(19) United States
(12) Patent Application Publication
(10) Pub. No.: US 2026/0095822 A1
(43) Pub. Date: Apr. 2, 2026

(54) REPORTING ENHANCEMENT FOR WIRELESS COMMUNICATIONS

(71) Applicant: Telefonaktiebolaget LM Ericsson (publ), Stockholm (SE)

(72) Inventors: Luca LUNARDI, Genoa (IT); Johan RUNE, Lidingö (SE); Ali PARICHEHREHTEROUJENI, Linköping (SE); Angelo CENTONZA, Granada (ES)

(21) Appl. No.: 19/111,378

(22) PCT Filed: Sep. 26, 2023
(86) PCT No.: PCT/SE2023/050941

§ 371 Date: Mar. 13, 2025

Related U.S. Application Data
(60) Provisional application No. 63/410,467, filed on Sep. 27, 2022.

(51) Int. Cl. H04W 36/00; H04B 17/318; H04W 74/0836

(52) U.S. Cl. CPC H04W 36/0058; H04B 17/328; H04W 36/0079; H04W 74/0836

(57) ABSTRACT

A method, system and apparatus are disclosed. According to one or more embodiments, a network node configured to communicate with a wireless device, where the network node configured to: receive an enriched report that has been enriched with enrichment information, where the enrichment information is related to an impact of unlicensed wireless spectrum operation on mobility procedures, and perform at least one action associated with a mobility related procedure, where the at least one action is associated with at least on the enrichment information.

### TECHNICAL FIELD

The present disclosure relates to wireless communications, and in particular, to enrichment information related to an impact of unlicensed wireless spectrum operation in mobility procedures.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) standards for wireless communication networks are also under development.

### Overall Architecture of Next Generation (NG)-Radio Access Network (RAN)

The overall architecture of NG-RAN is described in 3GPP standards such as in, for example, 3GPP TS 38.401 v16.6.0 (2021-06), as illustrated in FIG. 1.

The NG-RAN consists of a set of network nodes connected to the 5G core (5GC) through the NG interface.

As specified in 3GPP standards such as in, for example, 3GPP Technical Specification (TS) 38.300, NG-RAN could also consist of a set of ng-network nodes (e.g., eNB), an ng-network node may consist of an ng-network node-CU and one or more ng-network node-DU(s). An ng-network node-CU and an ng-network node-DU are connected via the W1 interface.

A network node (e.g., gNB) can support FDD mode, TDD mode or dual mode operation.

The network nodes can be interconnected through the Xn interface.

A network node may consist of a network node-CU (e.g., centralized unit) and one or more network node-DU(s) (e.g., distributed unit(s)). A network node-CU and a network node-DU is connected via F1 interface.

One network node-DU is connected to only one network node-CU.

NG, Xn and F1 are logical interfaces.

For NG-RAN, the NG and Xn-C interfaces for a network node consisting of a network node-CU and network node-DUs, terminate in the network node-CU. For EN-DC, the S1-U and X2-C interfaces for a network node consisting of a network node-CU and network node-DUs, terminate in the network node-CU. The network node-CU and connected network node-DUs are only visible to other network nodes and the 5GC as a network node.

The overall architecture for separation of network node-CU-CP (e.g., network node-CU-control plane) and network node-CU-UP (e.g., network node-CU-user plane) is illustrated in FIG. 2.

### NR in Unlicensed Spectrum (NR-U)

NR is targeting both licensed and unlicensed bands and a work item named NR-based Access to Unlicensed Spectrum (NR-U) was started in January 2019. Allowing unlicensed networks, i.e., networks that operate in shared spectrum (or unlicensed spectrum) to effectively use the available spectrum is an attractive approach to increase system capacity. Although unlicensed spectrum does not match the qualities of the licensed regime, solutions that allow an efficient use of it as a complement to licensed deployments have the potential to bring increased value to the 3GPP operators, and, ultimately, to the 3GPP industry as a whole. It is expected that some features in NR may need to be adapted to comply with the special characteristics of the unlicensed band as well as also different regulations. A subcarrier spacing of 15 or 30 kHz are candidates for NR-U Orthogonal Frequency Division Multiplexing (OFDM) numerologies for frequencies below 6 GHz.

When operating in unlicensed spectrum many regions in the world require a device to sense the medium (e.g., wireless medium) as free before transmitting, This, operation is often referred to as listen before talk (LBT).

Listen-before-talk (LBT) is designed for unlicensed spectrum co-existence with other radio access technologies (RATs). In LBT, a radio device (e.g., wireless device) applies a Clear Channel Assessment (CCA) check (i.e., channel sensing) before any transmission. The transmitter of the radio device involves energy detection (ED) over a time period compared to a certain threshold (ED threshold) in order to determine if a channel (e.g., medium) is idle.

LBT parameter settings (including ED) may be set for devices (e.g., wireless devices) in a network by a network node configuring the devices in the network. The limits may be set as pre-defined rules or tables defined in specifications or regulatory requirements for operation in a certain region. Such limits are part of the European Telecommunications Standards Institute (ETSI) harmonized standard in Europe as well as the 3GPP specification for operation of LTE/NR-U in unlicensed spectrum.

### Downlink Channel Access Procedures

a. Downlink channel access procedures are specified for a network node (e.g., eNB) operation Licensed-Assisted Access (LAA) Scell(s) on channel(s) and a network node (e.g., gNB) performing transmission(s) on channel(s) according to 3GPP TS 37.213 clause 4.1.
b. 3GPP TS 37.213, clause 4.1.1 (“Type 1 DL channel access procedure”) describes the channel access procedure to be performed by a network node, where the time duration spanned by the sensing slots that are sensed to be idle before a downlink transmission(s) is random.
   The network node may transmit a transmission after first sensing the channel to be idle during the sensing slot durations of a defer duration T_{d} and after the counter N is zero. The counter N is adjusted by sensing the channel for additional sensing slot duration(s) according to the steps below:
1) set N=Nᵢₙᵢₜ, where Nᵢₙᵢₜ is a random number uniformly distributed between 0 and CWₚ, and go to step 4;
2) if N>0 and the network node chooses to decrement the counter, set N=N−1;
3) sense the channel for an additional sensing slot duration, and if the additional sensing slot duration is idle, go to step 4; else, go to step 5;
4) if N=0, stop; else, go to step 2.
5) sense the channel until either a busy sensing slot is detected within an additional defer duration T_{d} or all the sensing slots of the additional defer duration T_{d} are detected to be idle;
6) if the channel is sensed to be idle during all the sensing slot durations of the additional defer duration T_{d}, go to step 4; else, go to step 5;
c. In the steps above:
T_{d} is the defer duration and it consists of a duration T_{f}=16 us immediately followed by mₚ consecutive sensing slot durations Tₛₗ, and T_{f} includes an idle sensing slot duration Tₛₗ at start of T_{f}.
CWₚ is the Contention Window with value CW_{min,p}<CWₚ≤CW_{max,p}
mₚ, CW_{min,p}, and CW_{max,p} are based on a Channel Access Priority Class (CAPC) p associated with the eNB/gNB transmission, as shown in Table 1.

TABLE 1
Channel Access Priority Class (CAPC)

| Channel | | | | | |
|---|---|---|---|---|---|
| Access | | | | | |
| Priority | | | | | |
| Class (p) | mₚ | CW_{min, p} | CW_{max, p} | T_{m cot, p} | allowed CWₚsizes |
| 1 | 1 | 3 | 7 | 2 ms | {3, 7} |
| 2 | 1 | 7 | 15 | 3 ms | {7, 15} |
| 3 | 3 | 15 | 63 | 8 or | {15, 31, 63} |
| | | | | 10 ms | |
| 4 | 7 | 15 | 1023 | 8 or | {15, 31, 63, 127, |
| | | | | 10 ms | 255, 511, 1023} |

Impact of LBT Failure in Random Access Preamble Transmission 3GPP TS 38.321 v17.1.0 describes the “Random Access Preamble transmission” in clause 5.1.3 (an excerpt reported below), including aspects related to LBT failure indication. The “LBT failure detection and recovery procedure” in clause 5.21.2 of the same 3GPP Technical Specification.

### Random Access Preamble Transmission (Excerpt of Clause 5.1.3)

The MAC entity shall, for each Random Access Preamble:

| | |
|---|---|
| 1> | if PREAMBLE_TRANSMISSION_COUNTER is greater than one; and |
| 1> | if the notification of suspending power ramping counter has not been |

received from lower layers; and

| | |
|---|---|
| 1> | if LBT failure indication was not received from lower layers for the last |

Random Access Preamble transmission; and

| | |
|---|---|
| 1> | if SSB or CSI-RS selected is not changed from the selection in the last |

Random Access Preamble transmission:

| | |
|---|---|
| 2> | increment PREAMBLE_POWER_RAMPING_COUNTER by 1. |

| | |
|---|---|
| 1> | select the value of DELTA_PREAMBLE according to clause 7.3 (e.g., of |

3GPP TS 38.321 v17.1.0);

| | |
|---|---|
| 1> | set PREAMBLE_RECEIVED_TARGET_POWER to |

preambleReceivedTargetPower + DELTA_PREAMBLE +
(PREAMBLE_POWER_RAMPING_COUNTER − 1) ×
PREAMBLE_POWER_RAMPING_STEP + POWER_OFFSET_2STEP_RA;

| | |
|---|---|
| 1> | except for contention-free Random Access Preamble for beam failure |

recovery request, compute the RA-RNTI associated with the PRACH occasion in which
the Random Access Preamble is transmitted;

| | |
|---|---|
| 1> | instruct the physical layer to transmit the Random Access Preamble using |

the selected PRACH occasion, corresponding RA-RNTI (if available),
PREAMBLE_INDEX, and PREAMBLE_RECEIVED_TARGET_POWER.

| | |
|---|---|
| 1> | if LBT failure indication is received from lower layers for this Random |

Access Preamble transmission:

| | |
|---|---|
| 2> | if lbt-FailureRecoveryConfig is configured: |

| | |
|---|---|
| 3> | perform the Random Access Resource selection procedure |

(see clause 5.1.2 (e.g., of 3GPP TS 38.321 v17.1.0)).

| | |
|---|---|
| 2> | else: |

| | |
|---|---|
| 3> | increment PREAMBLE_TRANSMISSION_COUNTER by 1; |
| 3> | if PREAMBLE_TRANSMISSION_COUNTER = |

preambleTransMax + 1:

| | |
|---|---|
| 4> | if the Random Access Preamble is transmitted on the |

SpCell:

| | |
|---|---|
| 5> | indicate a Random Access problem to upper |

layers;

| | |
|---|---|
| 5> | if this Random Access procedure was |

triggered for SI request:

| | |
|---|---|
| 6> | consider the Random Access |

procedure unsuccessfully completed.

| | |
|---|---|
| 4> | else if the Random Access Preamble is transmitted |

on an SCell:

| | |
|---|---|
| 5> | consider the Random Access procedure |

unsuccessfully completed.

| | |
|---|---|
| 3> | if the Random Access procedure is not completed: |

| | |
|---|---|
| 4> | perform the Random Access Resource selection |

procedure (see clause 5.1.2 (e.g., of 3GPP TS 38.321 v17.1.0)).

### 3GPP Discussion Concerning LBT Issues During Mobility

At RAN3 #115-e, in contribution R3-221978, it was proposed to send a message containing LBT failure indication from the target network node of an handover to the source network node of the handover, to aid the source network node in the handover failure cause analysis and optimize mobility configuration, as described below.

During handover procedure, as illustrated in the example of FIG. 3, for the case that LBT fails at the target network node, e.g., the target network node fails to send RAR/MSG4/MSG B to the wireless device due to unlicensed channel resources in target cell being unavailable, when T304 expires, from the wireless device point of view, it does not know LBT failure in the network, and it can trigger RLF report as legacy when HOF happens. Then, the source network node can receive the RLF report as legacy, since the information included in the RLF report is not NR-U relevant, the source network node would execute handover failure cause analysis according to the received RLF report and optimize mobility configuration as legacy, e.g., modify handover trigger threshold, or TTT for RRM measurement. However, there is a possibility that the actual failure cause is inappropriate LBT related configuration rather than mobility configuration, in such a case, modifying mobility configuration by the source network node is not essential and needs to be avoided.

To enable the source network node distinguish mobility issue (e.g., improper mobility configuration) from LBT issue (e.g., improper LBT configuration), the target network node can inform the source network node that LBT failure occurred in the target network node via a new introduced message or reusing the HANDOVER REPORT message. The source network node can make failure cause analysis based on the RLF report and LBT failure indication from the target network node, e.g., decide whether it is mobility issue or LBT issue or both. For example, if the source network node decides that it is a LBT issue and only LBT configuration at the target network node needs to be optimized, the source network node would keep the previous mobility configuration and inform the target network node to perform optimization for LBT configuration. For the target network node, it can optimize the LBT configuration after receiving the informing message from the source network node, or it may modify the LBT configuration optionally when it finds DL LBT failure happens.

Proposal 1: When HOF happens due to LBT failure at the target network node, the target network node can send an indication for LBT failure to the source network node for the purpose of failure cause analysis.

Proposal 2: The source network node would inform the target network node to optimize LBT configuration when it decides LBT configuration needs to be optimized based on the RLF report from the wireless device and the indication for LBT failure from the target network node.

At RAN3 #117-e, in contribution R3-224414, the same issue described above was discussed and in addition to the Handover case, a similar proposal for the handover scenario was described for the PSCell Change failure, the relevant text is described below:

For DL LBT failure, the target SpCell fails to send RAR/MSG4/MSG B to the wireless device in the case that unlicensed channel resources in target SpCell are unavailble due to unsuccessful LBT, when T304 expires, from the wireless device point of view, it does not know consistent LBT failure in the network, and it can trigger RLF report as legacy when HOF happens or SCG Failure Information message as legacy when PSCell change failure happens. Then, the receiving network node can receive the RLF report or SCG Failure Information message as legacy, since the information included in the RLF report or SCG Failure Information message is not NR-U relevant, the receiving network node would execute failure cause analysis as legacy, e.g., modify SpCell change related trigger threshold. However, there is a possibility that the acutual failure cause is inappropriate LBT related configuration rather than SpCell change configuration, in such a case, modifying SpCell change configuration may not be essential and may need to be avoided.

In 3GPP R17, this issue is raised but not fully discussed due to unavailable time. It is suggested to be considered in 3GPP R18, for example, to distinguish mobility issue (e.g., improper SpCell change configuration) from LBT issue (e.g., improper LBT configuration), the target SpCell can inform the source PCell that LBT failure occurred in the target SpCell via a new introduced message or reusing the HANDOVER REPORT message. The source PCell may make failure cause analysis based on the failure related information and LBT failure indication from the target SpCell, e.g. if the source PCell decides that it is a LBT issue, the source PCell would keep previous SpCell change configuration and inform the target SpCell to do optimization for LBT configuration.

Proposal 6: When HOF or SCG failure happens due to DL LBT failure at the target SpCell, the target SpCell can send an indication for LBT failure to the source PCell for the purpose of failure cause analysis.

At RAN3 #117-e, in contribution R3-224390, the impact of LBT issue in both uplink and downlink directions in handover scenario was described, and it was proposed that the target network node would store the complete downlink waiting period due to LBT issues in DL, and send this information to the source network node, and also that the wireless device would log the uplink waiting period due to LBT issues in UL as part of the RLF report, and this information would reach the source network node via the RLF report send by the target network node to the source network node over Xn. The relevant text from this contribution is described below.

Both the uplink (measurement reports and RACH) and downlink (RRCReconfiguration msg) might suffer from delays due to LBT. While uplink waiting periods can be logged on the wireless device side and reported with the RLF report, the DL waiting time is to be stored in the network node and has to be retrieved from the root cause analysis instance in the network node being responsible for problem, i.e., in case of a mobility related RLF not only the information of RLF report including UL waiting time is taken into account in the root cause analysis but also the DL waiting times are.

Observation 2: Delays due to LBT during the mobility procedure are impacting both uplink and downlink transmissions.

Observation 3: Information about downlink waiting periods is stored in the network node and has to be retrieved from there by the root cause analysing instance in the network node being responsible for problem.

Proposal 1: RAN WG3 may agree that waiting time of both transmission directions are to be considered which includes also the DL waiting time has to be stored in the corresponding network node and retrieved in case of RLF root cause analysis.

### Some Limitations Exist in the Published Technology

In particular, in the contributions R3-221978 and R3-224414, the network node responsible for performing the root cause analysis of the failure may receive the RLF report from the wireless device and the LBT failure indication has only a partial view of the problem. In particular, neither the target network node nor the source network node can be aware of issues that the wireless device may have encountered during the Random Access procedure due to LBT issue in the UL. The message “LBT failure indication” does not provide this information, since it is used by the target network node to inform the source network node that LBT failure occurred in the target network node. Also, it is indicated that “the information included in the RLF report is not NR-U relevant”.

The contribution in R3-224390 considers the impact of LBT issues in both uplink and downlink directions in a handover scenario. However, the contribution proposes to use the overall waiting time caused by LBT issues (the waiting time in UL is logged by the wireless device and reported to the network, the waiting time in DL is logged by a network node and sent to another network node). Firstly, the proposed measurements provide a generic view of the impact on LBT issues in the mobility. It is not clear, for example, whether the UL waiting time logged by the wireless device pertains to the handover preparation phase or the handover execution phase. Therefore, the network node performing the analysis may not be able to use this information in an effective manner.

### SUMMARY

Some embodiments advantageously provide methods, systems, and apparatuses for enrichment information related to an impact of unlicensed wireless spectrum operation in mobility procedures.

One or more embodiments described herein as discussed with respect to one or more methods that are captured by taking the example of RLF Report and CEF Report generated by a wireless device. However, the enhancements described herein may apply to all reports that make use of the measurements and logs such as to enhanced their use. For example, the Successful Handover Report or the Connection Establishment Failure report contain information on RACH access, which are enhanced by the methods described herein. The methods therefore not only apply to the case of RLF Report and CEF Report and the functionalities associated with them, but they apply to all the reports that include the information enhanced according to one or more embodiments. Examples of such reports can be the Successful Handover Report, the Connection Establishment Failure Report, the PSCell change/addition report, etc.

In one or more embodiments:
a wireless device may execute one or more of the following:
   receiving from a first network node (e.g., the source network node for a mobility event, for example, a handover) a configuration (e.g., a mobility configuration) for logging information concerning the impact of NR Unlicensed operation in mobility procedures, the information may be related to and/or associated with one or more of:
      transmission of RRC Measurement Reports
      transmission of Random Access Attempts
      execution of Random Access Procedures
   applying the received configuration
   logging the requested information and measurements
   receiving a request from a second network node (e.g., the target node of a mobility event) to send to the second network node enriched RLF reports and/or enriched RA reports and/or enriched Successful Handover Reports including the logged information and measurements. That is, “enriched” may refer to adding additional information (e.g., logged requested and/or measurements) compared to information included in one or more reports as defined in existing 3GPP standards.
      In one embodiment, the reports requested to be provided are all the reports where the new measurements and logged information are stored.
   sending the enriched RLF reports and/or enriched RA reports and/or enriched Successful Handover Reports including the logged information and measurements to the second network node
   In one embodiment, the first and second network node may be the same node.
a first network node may execute one or more of the following:
   configuring the wireless device for logging information concerning the impact of NR Unlicensed operation in mobility procedures (for the purpose of constructing an enriched RLF report and/or the enriched RA report, and/or successful handover report (SHR) and/or a successful PSCell Change/Addition report (SPR or SPCR), e.g., an enriched report includes additional and/or different information compared to the same report defined in one or more existing standards)
   receiving the enriched RLF reports and/or enriched RA reports and/or other relevant reports from a second network node
   (optionally) determines how to use the enriched RLF reports and/or enriched RA reports for Mobility Robustness Optimization (e.g., excluding them or use a certain weight for them compared to the non-enriched RLF reports and/or the non-enriched RA reports and/or other relevant reports, e.g., non-enriched reports may be those defined by existing standards)
a second network node may execute one or more of the following:
   optionally determining LBT failures and/or consistent LBT failures causing a delay or preventing the transmission of DL messages and indications comprised in a Random Access procedure, or causing a delay or preventing the transmission in reference signals (e.g. SSB beams)
   receiving enriched RLF reports and/or enriched RA reports from wireless devices attempting to access the second network node during the execution phase of a mobility procedure or of a network access procedure
   determines to send the enriched RLF reports and/or enriched RA reports to another network node (first network node) sends the enriched RLF reports and/or enriched RA reports to the first network node
   (optionally) determines how to use the enriched RLF reports and/or enriched RA reports for Mobility Robustness Optimization (e.g., excluding them or use a certain weight for them compared to the non-enriched RLF reports and/or the non-enriched RA reports)
the first network node may receive from the second network node the enriched RLF reports and the enriched RA reports:
   (optionally) determines how to use the enriched RLF reports and/or enriched RA reports for Mobility Robustness Optimization (e.g., excluding the received enriched RLF/RA reports in decisions concerning updates of mobility trigger points).

According to one aspect of the present disclosure, a network node configured to communicate with a wireless device is provided. The network node is configured to receive an enriched report that has been enriched with enrichment information where the enrichment information is related to an impact of unlicensed wireless spectrum operation on mobility procedures, and perform at least one action associated with a mobility related procedure where the at least one action is associated with at least on the enrichment information.

According to one or more embodiments of this aspect, the network node is further configured to cause transmission of a configuration to the wireless device for logging the enrichment information for one of a radio link failure, RLF, or a random access, RA, procedure.

According to one or more embodiments of this aspect, the enriched report is associated with one of: a random access attempt towards a target network node of a mobility event, or performing a random access procedure towards the target network node of the mobility event.

According to one or more embodiments of this aspect, the enriched report is associated with the random access procedure, the enrichment information includes at least one of: a last received signal strength indicator, RSSI, measurement before a listen before talk, LBT, failure occurred, an indication of LBT failure, an indication that a random access attempt was successfully transmitted and a message 2, Msg2, was not received, an indication that a random access response of a 4-step random access procedure has not been received, an indication that a message B, Msg B, of a 2-step random access procedure has not been received, or an indication that a preamble response has not been received.

According to one or more embodiments of this aspect, the network node is a target network node of a handover procedure, and where the at least one action includes one of: transmitting the enriched report to a source network node of the handover procedure for use in a mobility optimization, performing mobility optimization based on the enrichment information, excluding the enriched report when performing mobility optimization, or applying a first logical weight to the enriched report when performing mobility optimization, the first logical weight being different than a second logical weight applied to a non-enriched report

According to one or more embodiments of this aspect, the network node is a target network node of a handover procedure where the target network node is further configured to request the enriched report, and where the at least one action includes determining a failure type of a plurality of failure types associated with the enriched report.

According to one or more embodiments of this aspect, the network node is a target network node of a handover procedure, and where the network node is further configured to one of: determine the enriched report is associated with a handover procedure that failed in an execution phase due to listen before talk, LBT, failure, determine the enriched report is associated with a successful mobility procedure under a LBT issue, or determine the enriched report is associated with a connection establishment procedure.

According to one or more embodiments of this aspect, the network node is further configured to assign respective logical weights to the enrichment information and non-enrichment information included in the enriched report, where the at least one action is based on the assigned logical weights.

According to one or more embodiments of this aspect, the at least one action comprises changing at least one mobility parameter associated with the wireless device, where the changing of the at least one mobility parameter is not based on the non-enrichment information due to the assigned logical weight of the non-enrichment information.

According to one or more embodiments of this aspect, the network node is further configured to: determine at least one mobility parameter associated with the wireless device did not cause a radio link failure, RLF, and determine the RLF was caused based at least on the unlicensed wireless spectrum operation.

According to one or more embodiments of this aspect, the network node is a source network node, and where the source network node is further configured to assign respective logical weights to the enrichment information and non-enrichment information included in the enriched report, the at least one action being based on the assigned logical weights.

According to another aspect of the present disclosure, a wireless device configured to communicate with a network node is provided. The wireless device is configured to log enrichment information, the enrichment information being related to an impact of unlicensed wireless spectrum operation in mobility procedures, and cause transmission of an enriched report including the enrichment information.

According to one or more embodiments of this aspect, the wireless device is further configured to receive a configuration for logging the enrichment information for one of a radio link failure, RLF, or a random access, RA, procedure.

According to one or more embodiments of this aspect, the enriched report is associated with one of: a random access attempt toward a target network node of a mobility event, or performing a random access procedure towards the target network node of the mobility event.

According to one or more embodiments of this aspect, the enriched report is associated with the random access procedure, the enrichment information includes at least one of: a last received signal strength indicator, RSSI, measurement before a listen before talk, LBT, failure occurred; an indication of LBT failure; an indication that a random access attempt was successfully transmitted and a message 2, Msg2, was not received; an indication that a random access response of a 4-step random access procedure has not been received; an indication that a message B, Msg B, of a 2-step random access procedure has not been received; or an indication that a preamble response has not been received.

According to one or more embodiments of this aspect, the network node is a target network node of a handover procedure.

According to one or more embodiments of this aspect, the wireless device is further configured to receive a request for the enriched report.

According to one or more embodiments of this aspect, the wireless device is further configured to receive an indication of a change to at least one mobility parameter, where the change is not based on non-enrichment information included in the enrichment report.

According to one or more embodiments of this aspect, the network node is a source network node.

According to another aspect of the present disclosure, a method implemented by a network node that is configured to communicate with a wireless device is provided. An enriched report that has been enriched with enrichment information is received. The enrichment information is related to an impact of unlicensed wireless spectrum operation on mobility procedures, and performing at least one action associated with a mobility related procedure, the at least one action being associated with at least on the enrichment information.

According to one or more embodiments of this aspect, a configuration is transmitted to the wireless device for logging the enrichment information for one of a radio link failure, RLF, or a random access, RA, procedure.

According to one or more embodiments of this aspect, the enriched report is associated with one of: a random access attempt towards a target network node of a mobility event; or performing a random access procedure towards the target network node of the mobility event.

According to one or more embodiments of this aspect, the enriched report is associated with the random access procedure, the enrichment information includes at least one of: a last received signal strength indicator, RSSI, measurement before a listen before talk, LBT, failure occurred; an indication of LBT failure; an indication that a random access attempt was successfully transmitted and a message 2, Msg2, was not received; an indication that a random access response of a 4-step random access procedure has not been received; an indication that a message B, Msg B, of a 2-step random access procedure has not been received; or an indication that a preamble response has not been received.

According to one or more embodiments of this aspect, the network node is a target network node of a handover procedure, where the at least one action includes one of: transmitting the enriched report to a source network node of the handover procedure for use in a mobility optimization, performing mobility optimization based on the enrichment information, excluding the enriched report when performing mobility optimization, or applying a first logical weight to the enriched report when performing mobility optimization, the first logical weight being different than a second logical weight applied to a non-enriched report.

According to one or more embodiments of this aspect, the enriched report is requested. The network node is a target network node of a handover procedure, and the at least one action includes determining a failure type of a plurality of failure types associated with the enriched report.

According to one or more embodiments of this aspect, the network node is a target network node of a handover procedure, where one of: determining the enriched report is associated with a handover procedure that failed in an execution phase due to listen before talk, LBT, failure, determining the enriched report is associated with a successful mobility procedure under a LBT issue, or determining the enriched report is associated with a connection establishment procedure.

According to one or more embodiments of this aspect, respective logical weights are assigned to the enrichment information and non-enrichment information included in the enriched report, the at least one action being based on the assigned logical weights.

According to one or more embodiments of this aspect, the at least one action comprises changing at least one mobility parameter associated with the wireless device, the changing of the at least one mobility parameter not being based on the non-enrichment information due to the assigned logical weight of the non-enrichment information.

According to one or more embodiments of this aspect, at least one mobility parameter associated with the wireless device did not cause a radio link failure, RLF, is determined, and a determination is made that the RLF was caused based at least on the unlicensed wireless spectrum operation.

According to one or more embodiments of this aspect, respective logical weights are assigned to the enrichment information and non-enrichment information included in the enriched report, where the at least one action is based on the assigned logical weights, and the network node is a source network node.

According to another aspect of the present disclosure, a method implemented by a wireless device that is configured to communicate with a network node is provided.

Enrichment information is logged where the enrichment information is related to an impact of unlicensed wireless spectrum operation in mobility procedures. An enriched report including the enrichment information is transmitted.

According to one or more embodiments of this aspect, a configuration for logging the enrichment information for one of a radio link failure, RLF, or a random access, RA, procedure is received.

According to one or more embodiments of this aspect, the enriched report is associated with one of: a random access attempt toward a target network node of a mobility event; or performing a random access procedure towards the target network node of the mobility event.

According to one or more embodiments of this aspect, the enriched report is associated with the random access procedure, the enrichment information includes at least one of: a last received signal strength indicator, RSSI, measurement before a listen before talk, LBT, failure occurred; an indication of LBT failure; an indication that a random access attempt was successfully transmitted and a message 2, Msg2, was not received; an indication that a random access response of a 4-step random access procedure has not been received; an indication that a message B, Msg B, of a 2-step random access procedure has not been received; or an indication that a preamble response has not been received.

According to one or more embodiments of this aspect, the network node is a target network node of a handover procedure.

According to one or more embodiments of this aspect, a request for the enriched report is received.

According to one or more embodiments of this aspect, an indication of a change to at least one mobility parameter is received, where the change is not based on non-enrichment information included in the enrichment report.

According to one or more embodiments of this aspect, the network node is a source network node.

According to another aspect of the present disclosure, a computer-readable medium is provided. The computer-readable medium comprises instructions which, when executed on at least one processor, cause the at least one processor to perform a wireless device method or network node method described herein.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of a NG-RAN overall architecture;

FIG. 2 is a diagram of an overall architecture for separation of network node-CU-CP and network node-CU-UP;

FIG. 3 is a diagram of LBT failure at the target network node;

FIG. 4 is a schematic diagram of an example network architecture illustrating a communication system connected via an intermediate network to a host computer according to the principles in the present disclosure;

FIG. 5 is a block diagram of a host computer communicating via a network node with a wireless device over an at least partially wireless connection according to some embodiments of the present disclosure;

FIG. 6 is a flowchart illustrating example methods implemented in a communication system including a host computer, a network node and a wireless device for executing a client application at a wireless device according to some embodiments of the present disclosure;

FIG. 7 is a flowchart illustrating example methods implemented in a communication system including a host computer, a network node and a wireless device for receiving user data at a wireless device according to some embodiments of the present disclosure;

FIG. 8 is a flowchart illustrating example methods implemented in a communication system including a host computer, a network node and a wireless device for receiving user data from the wireless device at a host computer according to some embodiments of the present disclosure;

FIG. 9 is a flowchart illustrating example methods implemented in a communication system including a host computer, a network node and a wireless device for receiving user data at a host computer according to some embodiments of the present disclosure;

FIG. 10 is a flowchart of an example process in a network node according to some embodiments of the present disclosure;

FIG. 11 is a flowchart of another example process in a network node according to some embodiments of the present disclosure;

FIG. 12 is a flowchart of an example process in a wireless device according to some embodiments of the present disclosure; and

FIG. 13 is a flowchart of an example process in a wireless device according to some embodiments of the present disclosure.

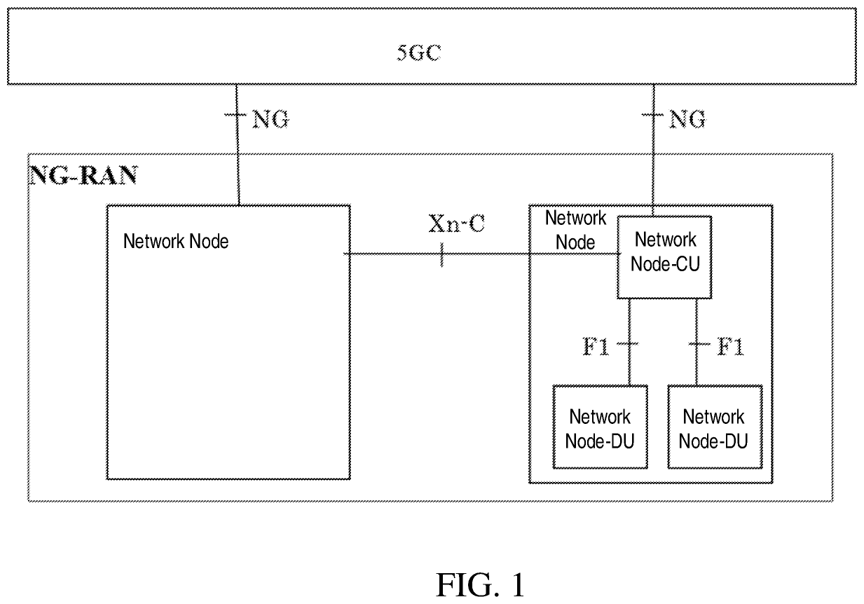

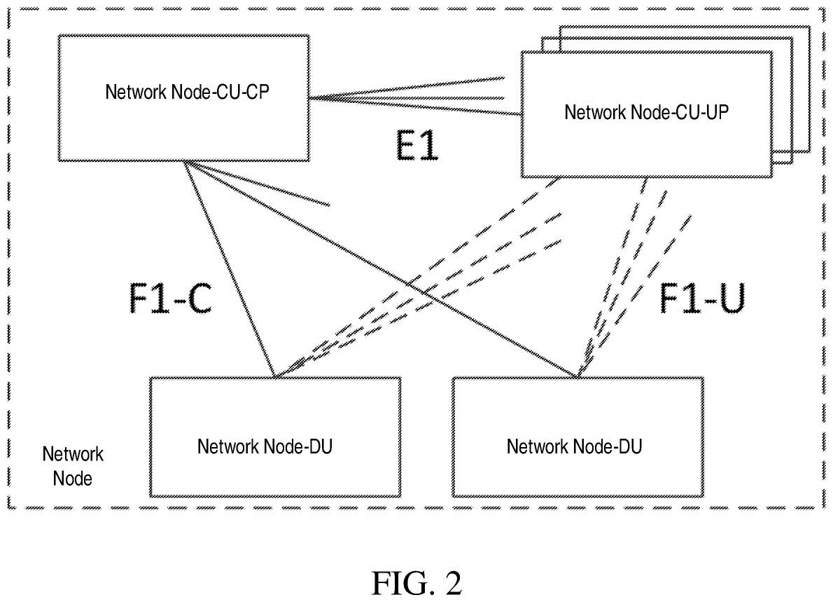

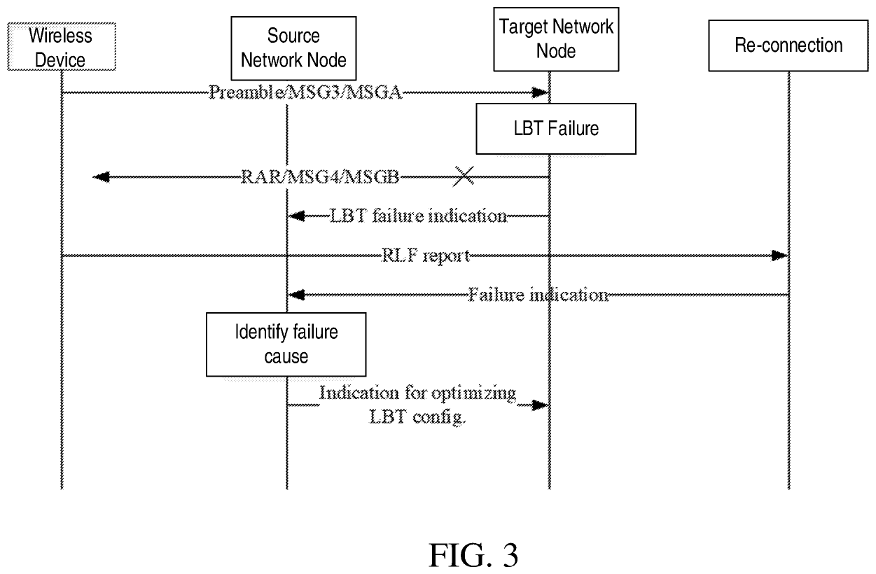

### DETAILED DESCRIPTION

Before describing in detail example embodiments, it is noted that the embodiments reside primarily in combinations of apparatus components and processing steps related to enrichment information related to an impact of unlicensed wireless spectrum operation in mobility procedures. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), RAN node, an OAM, core network node, an SMO, a Network Management System (NMS), a Non-Real Time RAN Intelligent Controller (Non-RT RIC), a Real-Time RAN Intelligent Controller (RT-RIC), en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB, a Cloud-based network function, a Cloud-based centralized training node, an integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

The terms NR-U and NR Unlicensed may be used interchangeably herein.

The description provided for NR Unlicensed should not be regarded as limiting in terms of applicability of the present disclosure, to different 3GPP generations, i.e., the present disclosure is applicable to 3GPP generations preceding NR (such as LTE) and to 3GPP generation following NR, such as 6G, as long as wireless device and network node operates in shared spectrum.

3GPP such as, for example, 3GPP TS 37.213 v17.1.0 (2022-03), clause 4 specifies some general terminology applicable to Channel access procedure for shared spectrum (e.g., for NR-U in case of NR, Licensed Assisted Access, or LAA in case of LTE) where one or more of the following definitions may apply to one or more embodiments described herein:
A channel refers to a carrier or a part of a carrier consisting of a contiguous set of resource blocks (RBs) on which a channel access procedure is performed in shared spectrum.
A channel access procedure is a procedure based on sensing that evaluates the availability of a channel for performing transmissions. The basic unit for sensing is a sensing slot with a duration Tₛₗ=9 us. The sensing slot duration Tₛₗ is considered to be idle if a network node or a wireless device senses the channel during the sensing slot duration, and determines that the detected power for at least 4 us within the sensing slot duration is less than energy detection threshold X_{Thresh}. Otherwise, the sensing slot duration Tₛₗ is considered to be busy.
A channel occupancy refers to transmission(s) on channel(s) by network node(s)/wireless device(s) after performing the corresponding channel access procedures in this clause.
A Channel Occupancy Time refers to the total time for which network node/wireless device and any network node/wireless device(s) sharing the channel occupancy perform transmission(s) on a channel after a network node/wireless device performs the corresponding channel access procedures described in this clause. For determining a Channel Occupancy Time, if a transmission gap is less than or equal to 25 us, the gap duration is counted in the channel occupancy time. A channel occupancy time can be shared for transmission between a network node and the corresponding wireless device(s).
A DL transmission burst is defined as a set of transmissions from a network node without any gaps greater than 16 us. Transmissions from a network node separated by a gap of more than 16 us are considered as separate DL transmission bursts. A network node can transmit transmission(s) after a gap within a DL transmission burst without sensing the corresponding channel(s) for availability.
A UL transmission burst is defined as a set of transmissions from a wireless device without any gaps greater than 16 us. Transmissions from a wireless device separated by a gap of more than 16 us are considered as separate UL transmission bursts. A wireless device can transmit transmission(s) after a gap within a UL transmission burst without sensing the corresponding channel(s) for availability.
A discovery burst refers to a DL transmission burst including a set of signal(s) and/or channel(s) confined within a window and associated with a duty cycle. The discovery burst can be any of the following:
   Transmission(s) initiated by a network node that includes a primary synchronization signal (PSS), secondary synchronization signal (SSS) and cell-specific reference signal(s) (CRS) and may include non-zero power CSI reference signals (CSI-RS).
   Transmission(s) initiated by a network node that includes at least an SS/PBCH block consisting of a primary synchronization signal (PSS), secondary synchronization signal (SSS), physical broadcast channel (PBCH) with associated demodulation reference signal (DM-RS) and may also include CORESET for PDCCH scheduling PDSCH with SIB1, and PDSCH carrying SIB1 and/or non-zero power CSI reference signals (CSI-RS).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

One or more embodiments described herein may also apply to ng-network node and W1 interface, if not explicitly specified otherwise.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide enrichment information related to an impact of unlicensed wireless spectrum operation in mobility procedures.

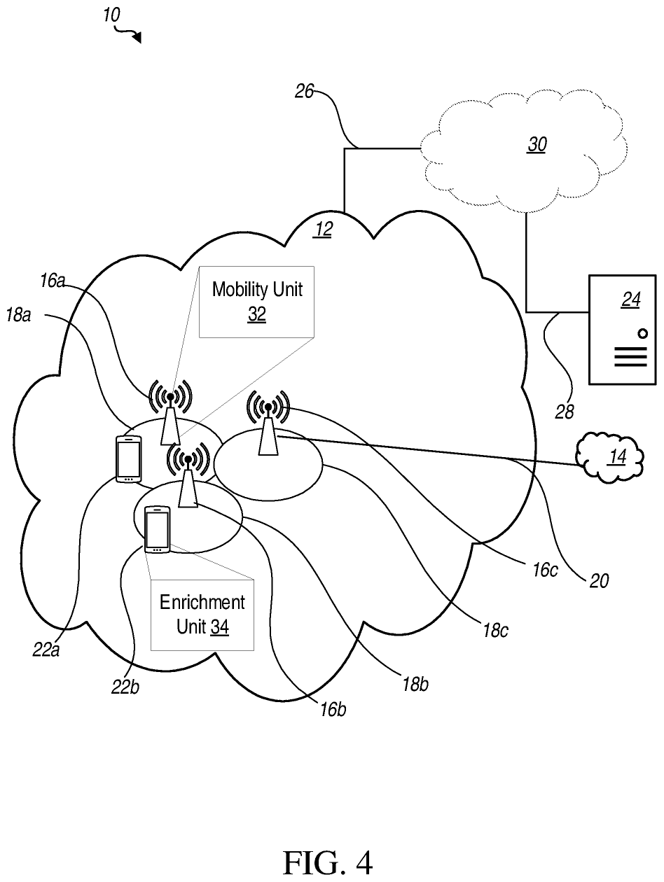

Referring again to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 4 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a mobility unit 32 which is configured to perform one or more network node 16 functions described herein such as with respect to enrichment information related to an impact of unlicensed wireless spectrum operation in mobility procedures. A wireless device 22 is configured to include an enrichment unit 34 which is configured to perform one or more wireless device 22 functions as described herein such as with respect to enrichment information related to an impact of unlicensed wireless spectrum operation in mobility procedures.

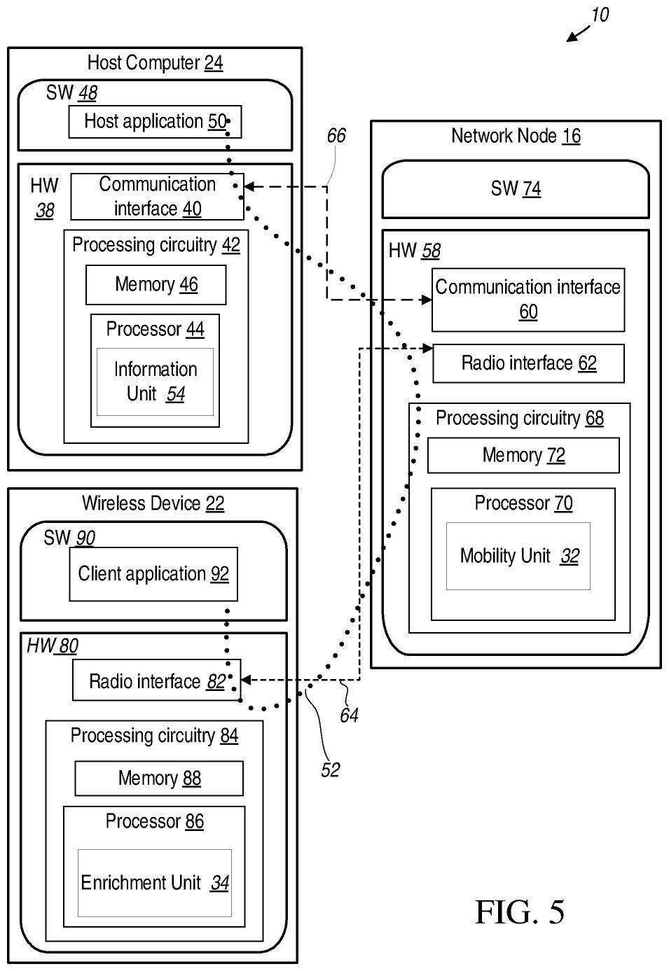

Example implementations, in accordance with an embodiment, of the WD 22, network node 16 and host computer 24 discussed in the preceding paragraphs will now be described with reference to FIG. 5. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to one or more of process, analyze, receive, transmit, provide, relay, forward, communicate, store, etc. information such as enrichment information.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include mobility unit 32 configured to perform one or more network node 16 functions as described herein such as with respect to enrichment information related to an impact of unlicensed wireless spectrum operation in mobility procedures.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an enrichment unit 34 configured to perform one or more wireless device 22 functions as described herein such as with respect to enrichment information related to an impact of unlicensed wireless spectrum operation in mobility procedures.

In some embodiments, the inner workings of the network node 16, WD 22, and host computer 24 may be as shown in FIG. 5 and independently, the surrounding network topology may be that of FIG. 4.

In FIG. 5, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

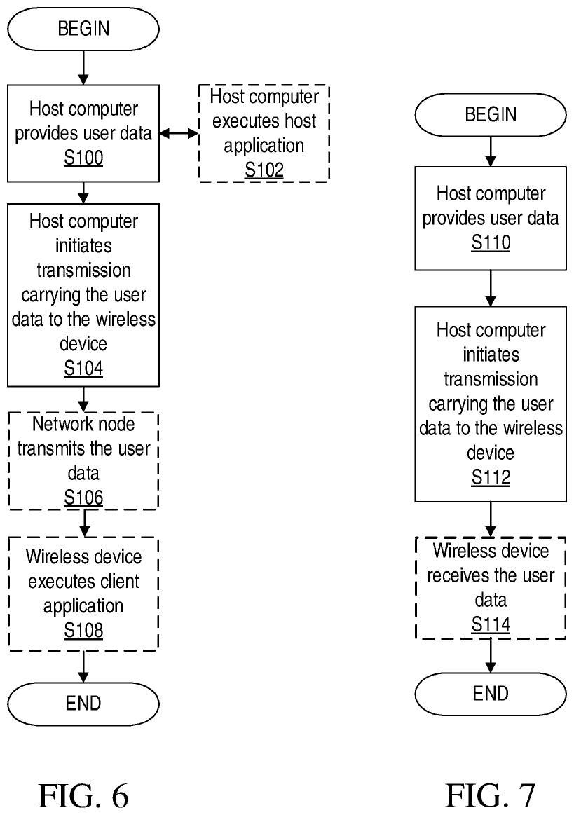

Although FIGS. 4 and 5 show various “units” such as mobility unit 32, and enrichment unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry. FIG. 6 is a flowchart illustrating an example method implemented in a communication system, such as, for example, the communication system of FIGS. 4 and 5, in accordance with one embodiment. The communication system may include a host computer 24, a network node 16 and a WD 22, which may be those described with reference to FIG. 5. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 7 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

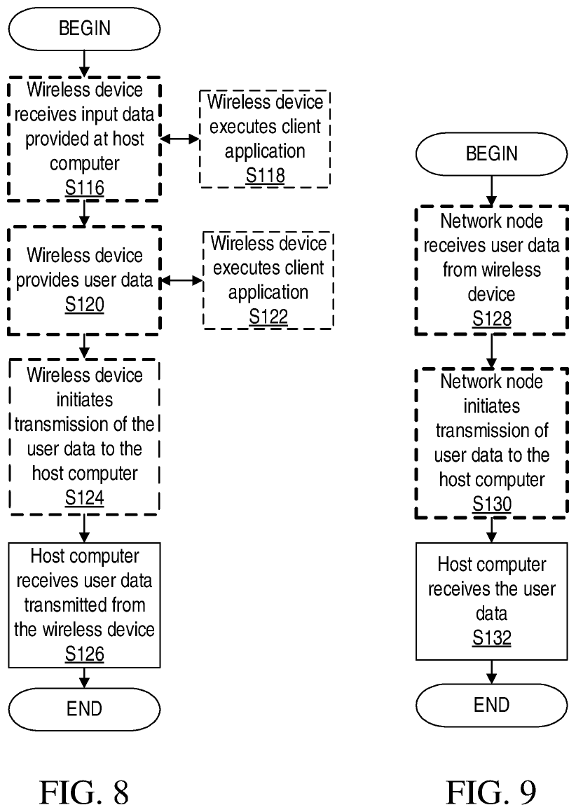

FIG. 8 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 9 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

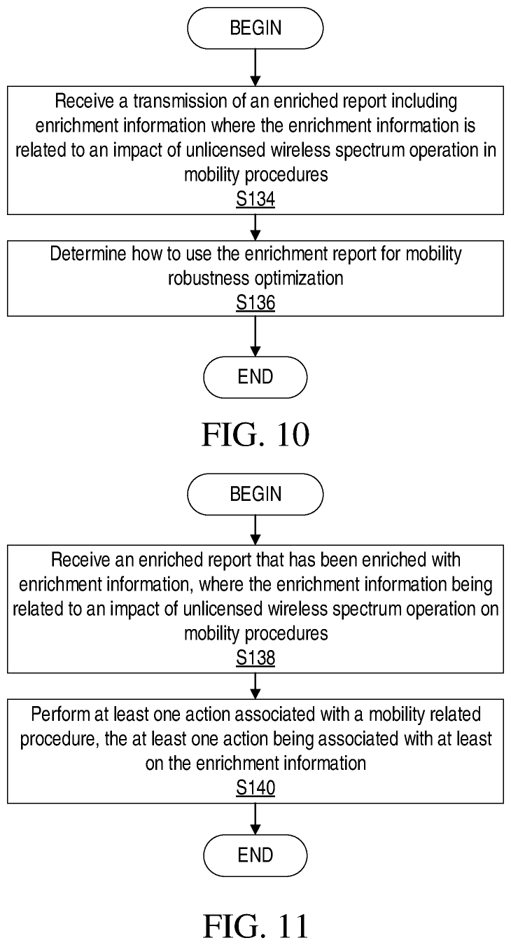

FIG. 10 is a flowchart of an example process in a network node 16 according to one or more embodiments of the present disclosure. One or more blocks described herein may be performed by one or more elements of network node 16 such as by one or more of processing circuitry 68 (including the mobility unit 32), processor 70, radio interface 62 and/or communication interface 60. Network node 16 is configured to receive (Block S134) a transmission of an enriched report including enrichment information where the enrichment information is related to an impact of unlicensed wireless spectrum operation in mobility procedures, as described herein. Network node 16 is configured to determine (Block S136) how to use the enrichment report for mobility robustness optimization, as described herein.

According to one or more embodiments, the processing circuitry 68 is configured to cause transmission of a configuration to the wireless device 22 for logging the enrichment information for one of a radio link failure, RLF, report and a random access, RA, report.

According to one or more embodiments, the report is related to one of: a radio resource control, RRC, measurement report; random access attempts; and random access procedures.

According to one or more embodiments, when the report is related to the RRC measurement report, the enrichment information corresponds to any of: an energy detection threshold used by the wireless device at a time the LBT failure occurred; an energy detection threshold configured for the wireless device by the network node; an actual energy detection threshold used by the wireless device as part of a LBT procedure;

a most recent available RSSI measurement before the LBT failure occurred; a flag indicating that the RRC measurement report could not be sent due to LBT failure; a flag indicating that the RRC measurement report could not be sent due to consistent LBT failure; the number of times the wireless devices has tried to access the channel before successful transmission of the measurement report; RSSI measurement per channel access taken for each attempt to transmit the RRC Measurement Report message that failed due to LBT failure; an indication of what message was attempted to be signaled for each attempted channel access attempt; an average RSSI value of all RSSI measurements during the at least one attempt to transmit the RRC measurement report message; and a number of LBT failures that occurred while the wireless device was attempting to transmit the RRC measurement report and a notification that the attempt was blocked due to LBT failures.

According to one or more embodiments, when the report is related to the random access procedure that is toward a target network node of a mobility event, the enrichment information corresponds to any of: an energy detection threshold used by the wireless device at a time the LBT failure occurred; an energy detection threshold used by the wireless device for all channel access attempts during a random access attempt; one of an average, lowest and highest energy detection threshold used by the wireless device for the channel access attempts during a random access procedure; an energy detection threshold configured for the wireless device by the network node; a last RSSI measurement before the LBT failure occurred; an indication of LBT failure; an indication that a random access attempt was successfully transmitted and a message 2, Msg2, was not received; an indication that a message A, Msg A, for a 2-step random access procedure was successfully transmitted and a message B, Msg B, was not received; an indication that a message 4, Msg 4, was successfully received for a 4-step random access procedure; an indication that a message B, Msg B, was successfully received for a 2-step random access procedure; a number of LBT failures or channel access attempts during a random access attempt; a RSSI measurement per channel access associated to an attempt to transmit a random access preamble in a 4-step random access procedure that failed due to LBT failure; a RSSI measurement per channel access associated to an attempt to transmit a message A, Msg A, in a 2-step random access procedure that failed due to LBT failure; a RSSI measurement for a successful attempt in transmitting a random access preamble in a 4-step random access procedure; a RSSI measurement for a successful attempt in transmitting a message A, Msg A, in a 2-step random access procedure; a RSSI measurement for a failed attempt to transmit a random access preamble in a 4-step random access procedure; one of an average, minimum, and maximum RSSI value of all RRSI measurements during at least one attempt to transmit a random access preamble in a 4-step random access procedure; one of an average, minimum, and maximum RSSI value of all RRSI measurements during at least one attempt to transmit a message A, Msg A, in a 2-step random access procedure; one of an average, minimum, and maximum RSSI value of all RRSI measurements during at least one attempt to transmit a message 3, Msg 3, in the 4-step random access procedure; one of an average, minimum, and maximum RSSI value of all RRSI measurements during at least one attempt to transmit a random access preamble in a 4-step random access procedure in conjunction with LBT failures; one of an average, minimum, and maximum RSSI value of all RRSI measurements during at least one attempt to transmit a message A, Msg A, in a 2-step random access procedure in conjunction with LBT failures; one of an average, minimum, and maximum RSSI value of all RRSI measurements during at least one attempt to transmit a message 3, Msg 3, in the 4-step random access procedure in conjunction with LBT failures; an indication that a random access attempt failed due to reaching a maximum number of LBT failures; an indication that a matching random access response of a 4-step random access procedure has not been received; an indication that a matching message B, Msg B, of a 2-step random access procedure has not been received; and an indication that a matching preamble response has not been received.

FIG. 11 is a flowchart of another example process in a network node 16 according to one or more embodiments of the present disclosure. One or more blocks described herein may be performed by one or more elements of network node 16 such as by one or more of processing circuitry 68 (including the mobility unit 32), processor 70, radio interface 62 and/or communication interface 60. Network node 16 is configured to receive (Block S138) an enriched report that has been enriched with enrichment information, the enrichment information being related to an impact of unlicensed wireless spectrum operation on mobility procedures, as described herein.

Network node 16 is configured to perform (Block S140) at least one action associated with a mobility related procedure, the at least one action being associated with at least on the enrichment information, as described herein.

According to one or more embodiments, the network node 16 is further configured to cause transmission of a configuration to the wireless device 22 for logging the enrichment information for one of a radio link failure, RLF, or a random access, RA, procedure.

According to one or more embodiments, the enriched report is associated with one of: a random access attempt towards a target network node 16 of a mobility event; or performing a random access procedure towards the target network node 16 of the mobility event.

According to one or more embodiments, the enriched report is associated with the random access procedure, the enrichment information includes at least one of: a last received signal strength indicator, RSSI, measurement before a listen before talk, LBT, failure occurred; an indication of LBT failure; an indication that a random access attempt was successfully transmitted and a message 2, Msg2, was not received; an indication that a random access response of a 4-step random access procedure has not been received; an indication that a message B, Msg B, of a 2-step random access procedure has not been received; or an indication that a preamble response has not been received.

According to one or more embodiments, the network node 16 is a target network node 16 of a handover procedure, and the at least one action includes one of: transmitting the enriched report to a source network node 16 of the handover procedure for use in a mobility optimization, performing mobility optimization based on the enrichment information, excluding the enriched report when performing mobility optimization, or applying a first logical weight to the enriched report when performing mobility optimization, the first logical weight being different than a second logical weight applied to a non-enriched report

According to one or more embodiments, the network node 16 is a target network node 16 of a handover procedure, where the target network node 16 is further configured to request the enriched report, and where the at least one action includes determining a failure type of a plurality of failure types associated with the enriched report.

According to one or more embodiments, the network node 16 is a target network node 16 of a handover procedure, and where the network node 16 is further configured to one of: determine the enriched report is associated with a handover procedure that failed in an execution phase due to listen before talk, LBT, failure; determine the enriched report is associated with a successful mobility procedure under a LBT issue; or determine the enriched report is associated with a connection establishment procedure.

According to one or more embodiments, the network node 16 is further configured to assign respective logical weights to the enrichment information and non-enrichment information included in the enriched report, where the at least one action is based on the assigned logical weights.

According to one or more embodiments, the at least one action comprises changing at least one mobility parameter associated with the wireless device 22, where the changing of the at least one mobility parameter is not based on the non-enrichment information due to the assigned logical weight of the non-enrichment information.

According to one or more embodiments, the network node 16 is further configured to: determine at least one mobility parameter associated with the wireless device 22 did not cause a radio link failure, RLF, and determine the RLF was caused based at least on the unlicensed wireless spectrum operation.

According to one or more embodiments, the network node 16 is a source network node 16, and where the source network node 16 is further configured to assign respective logical weights to the enrichment information and non-enrichment information included in the enriched report, and where the at least one action is based on the assigned logical weights.

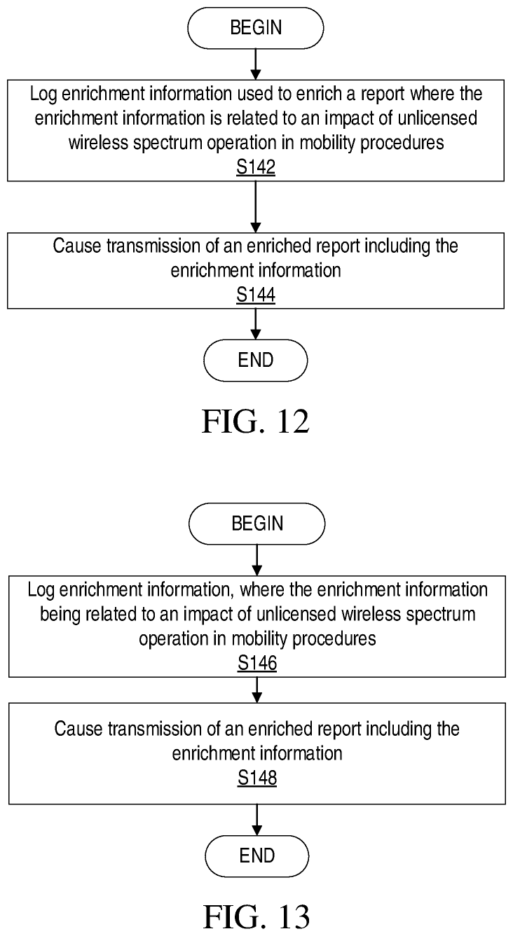

FIG. 12 is a flowchart of an example process in a wireless device 22 according to some embodiments of the present disclosure. One or more blocks described herein may be performed by one or more elements of wireless device 22 such as by one or more of processing circuitry 84 (including the enrichment unit 34), processor 86, radio interface 82 and/or communication interface 60. Wireless device 22 is configured to log (Block S142) enrichment information used to enrich a report where the enrichment information is related to an impact of unlicensed wireless spectrum operation in mobility procedures, as described herein. Wireless device 22 is configured to cause (Block S144) transmission of an enriched report including the enrichment information, as described herein.

According to one or more embodiments, the processing circuitry 84 is configured to receive a configuration for logging the enrichment information for one of a radio link failure, RLF, report and a random access, RA, report.

According to one or more embodiments, the report is related to one of: a radio resource control, RRC, measurement report; random access attempts; and random access procedures.

According to one or more embodiments, when the report is related to the RRC measurement report, the processing circuitry 84 is further configured to determine a listen before talk, LBT, procedure has failed at least once when trying to send the RRC measurement report w here the logging of the enrichment information is based on the determination of the at least one failure of the LBT procedure.

According to one or more embodiments, the enrichment information corresponds to any of: an energy detection threshold used by the wireless device at a time the LBT failure occurred; an energy detection threshold configured for the wireless device by the network node; an actual energy detection threshold used by the wireless device as part of a LBT procedure; a most recent available RSSI measurement before the LBT failure occurred; a flag indicating that the RRC measurement report could not be sent due to LBT failure; a flag indicating that the RRC measurement report could not be sent due to consistent LBT failure; the number of times the wireless devices has tried to access the channel before successful transmission of the measurement report; RSSI measurement per channel access taken for each attempt to transmit the RRC Measurement Report message that failed due to LBT failure; an indication of what message was attempted to be signaled for each attempted channel access attempt; an average RSSI value of all RSSI measurements during the at least one attempt to transmit the RRC measurement report message, and a number of LBT failures that occurred while the wireless device was attempting to transmit the RRC measurement report and a notification that the attempt was blocked due to LBT failures.

According to one or more embodiments, when the report is related to the random access procedure that is toward a target network node of a mobility event, the processing circuitry being further configured to detect a radio link failure, RLF, while attempting to access a cell of a target network node of a mobility procedure and determine a listen before talk, LBT, failure in the uplink occurred while attempting to transmit a random access message or executing a random access procedure.

According to one or more embodiments, the enrichment information corresponds to any of: an energy detection threshold used by the wireless device at a time the LBT failure occurred; an energy detection threshold used by the wireless device for all channel access attempts during a random access attempt; one of an average, lowest and highest energy detection threshold used by the wireless device for the channel access attempts during a random access procedure; an energy detection threshold configured for the wireless device by the network node; a last RSSI measurement before the LBT failure occurred; an indication of LBT failure; an indication that a random access attempt was successfully transmitted and a message 2, Msg2, was not received; an indication that a message A, Msg A, for a 2-step random access procedure was successfully transmitted and a message B, Msg B, was not received; an indication that a message 4, Msg 4, was successfully received for a 4-step Random Access procedure; an indication that a message B, Msg B, was successfully received for a 2-step Random Access procedure; an number of LBT failures or channel access attempts during a random access attempt; a RSSI measurement per channel access associated to an attempt to transmit a random access preamble in a 4-step random access procedure that failed due to LBT failure; a RSSI measurement per channel access associated to an attempt to transmit a message A, Msg A, in a 2-step random access procedure that failed due to LBT failure; a RSSI measurement for a successful attempt in transmitting a random access preamble in a 4-step random access procedure; a RSSI measurement for a successful attempt in transmitting a message A, Msg A, in a 2-step random access procedure; a RSSI measurement for a failed attempt to transmit a random access preamble in a 4-step random access procedure; one of an average, minimum, and maximum RSSI value of all RRSI measurements during at least one attempt to transmit a random access preamble in a 4-step random access procedure; one of an average, minimum, and maximum RSSI value of all RRSI measurements during at least one attempt to transmit a message A, Msg A, in a 2-step Random Access procedure; one of an average, minimum, and maximum RSSI value of all RRSI measurements during at least one attempt to transmit a message 3, Msg 3, in the 4-step Random Access procedure; one of an average, minimum, and maximum RSSI value of all RRSI measurements during at least one attempt to transmit a random access preamble in a 4-step Random Access procedure in conjunction with LBT failures; one of an average, minimum, and maximum RSSI value of all RRSI measurements during at least one attempt to transmit a message A, Msg A, in a 2-step random access procedure in conjunction with LBT failures; one of an average, minimum, and maximum RSSI value of all RRSI measurements during at least one attempt to transmit a message 3, Msg 3, in the 4-step Random Access procedure in conjunction with LBT failures; an indication that a random access attempt failed due to reaching a maximum number of LBT failures; an indication that a matching random access response of a 4-step random access procedure has not been received; an indication that a matching message B, Msg B, of a 2-step random access procedure has not been received; and an indication that a matching preamble response has not been received.

FIG. 13 is a flowchart of another example process in a wireless device 22 according to some embodiments of the present disclosure. One or more blocks described herein may be performed by one or more elements of wireless device 22 such as by one or more of processing circuitry 84 (including the enrichment unit 34), processor 86, radio interface 82 and/or communication interface 60. Wireless device 22 is configured to log (Block S146) enrichment information, where the enrichment information is related to an impact of unlicensed wireless spectrum operation in mobility procedures, as described herein. Wireless device 22 is configured to cause (Block S148) transmission of an enriched report including the enrichment information, as described herein.

According to one or more embodiments, the wireless device 22 is further configured to receive a configuration for logging the enrichment information for one of a radio link failure, RLF, or a random access, RA, procedure.

According to one or more embodiments, the enriched report is associated with one of: a random access attempt toward a target network node 16 of a mobility event; or performing a random access procedure towards the target network node 16 of the mobility event.

According to one or more embodiments, the enriched report is associated with the random access procedure, the enrichment information includes at least one of: a last received signal strength indicator, RSSI, measurement before a listen before talk, LBT, failure occurred; an indication of LBT failure; an indication that a random access attempt was successfully transmitted and a message 2, Msg2, was not received; an indication that a random access response of a 4-step random access procedure has not been received; an indication that a message B, Msg B, of a 2-step random access procedure has not been received; or an indication that a preamble response has not been received.

According to one or more embodiments, the network node 16 is a target network node 16 of a handover procedure.

According to one or more embodiments, the wireless device 22 is further configured to receive a request for the enriched report.

According to one or more embodiments, the wireless device 22 is further configured to receive an indication of a change to at least one mobility parameter, where the change is not based on non-enrichment information included in the enrichment report.

According to one or more embodiments, the network node 16 is a source network node 16.

Having described the general process flow of arrangements of the disclosure and having provided examples of hardware and software arrangements for implementing the processes and functions of the disclosure, the sections below provide details and examples of arrangements for enrichment information related to an impact of unlicensed wireless spectrum operation in mobility procedures.

Some embodiments provide enrichment information related to an impact of unlicensed wireless spectrum operation in mobility procedures. One or more wireless device 22 functions described below may be performed by one or more of processing circuitry 84, processor 86, enrichment unit 34, radio interface 82, etc. One or more network node 16 functions described below may be performed by one or more of processing circuitry 68, processor 70, mobility unit 32, radio interface 62, etc.

### One or More Embodiments for a Wireless Device 22

In one embodiment, a wireless device 22 can (optionally) receive from a network node 16 a configuration for logging information for an RLF report and/or an Random Access (RA) report and/or other relevant reports that have been enriched with new information, the information concerning the impact of NR Unlicensed operation in mobility procedures, and in particular related to:
RRC Measurement Reports
Random Access Attempts
Random Access Procedures

In one embodiment a wireless device 22 can (optionally) receive from a network node a request for reporting RLF report and/or Random Access (RA) report and/or successful handover report (SHR) and/or a successful PSCell change/addition report (SPR or SPCR) and/or other relevant reports enriched with new information concerning the impact of NR Unlicensed operation in mobility procedures, and in particular related to:
RRC Measurement Report
Random Access Attempts
Random Access Procedures

Concerning the transmission of RRC Measurement Report, methods are executed by a wireless device 22 according to the following steps:
a wireless device 22, upon detecting a Radio Link Failure following an attempt to send a RRC Measurement Report messages carrying information of radio related events (e.g., event A3, or event A5), where such an attempt was not successful due to LBT failure, i.e., an RRC Measurement Report message that can trigger the initiation of a mobility event (such as a handover preparation procedure or PSCell change/addition procedure),
if the wireless device 22 has experienced one or more LBT failure in UL when trying to send the RRC Measurement Report message (i.e., the wireless device 22 failed to access the NR Unlicensed shared spectrum because the channel access procedure indicated the channel as busy)
(optional) if the wireless device 22 has received from a network node 16 a configuration for logging information for an enriched RLF report and/or an enriched Random Access (RA) report, the information concerning the impact of NR Unlicensed operation in transmission of RRC Measurement Report
the wireless device 22 logs at least part of the first information listed below, related to NR Unlicensed (or LBT issues) impact for RRC Measurement Report
(optional) if the wireless device 22 has received from a network node 16 a request for reporting at least part of the first information listed below for an enriched RLF report and/or an enriched Random Access (RA) report (for RRC Measurement Report)
the wireless device 22 determines an enriched Radio Link Failure Report and/or an enriched Random Access Report comprising at least part of the first information listed below (for RRC Measurement Report)
the wireless device 22 sends to the network node 16 the enriched Radio Link Failure Report and/or Random Access Report including at least part of the first information listed below (for RRC Measurement Report example)

First information concerning the impact of NR Unlicensed operation in the transmission of RRC Measurement Report is one or more of:
the Energy Detection Threshold used by the wireless device 22 at the time the LBT failure occurred (or the closest instant in time compared to the LBT failure)
the Energy Detection Threshold configured for the wireless device 22 by the network/network node 16
the actual Energy Detection Threshold used by the wireless device 22 as part of LBT procedure
the latest available RSSI measurement before the LBT failure occurred
a flag indicating that the RRC Measurement Report could not be sent due to LBT failure
a flag indicating that the RRC Measurement Report could not be sent due to consistent LBT failure
the number of times wireless device 22 tried to access the channel before successful transmission of the measurement report
RSSI measurement(s) per channel access taken for each attempt to transmit the RRC Measurement Report message that failed due to LBT failure
An indication of what message was attempted to be signaled for each attempted channel access attempt, for example, Msg3, Msg5.
The average RSSI value of all RSSI measurements during the attempts to transmit the RRC Measurement Report message
the number of LBT failures occurred while the wireless device 22 was attempting to transmit the RRC Measurement Report message and the a notification that the attempt(s) was (were) blocked due to LBT failures.

Concerning the Random Access attempts and Random Access procedures towards a target network node 16 of a mobility event, methods may be executed by a wireless device 22 as follows:
a wireless device 22, upon detecting a Radio Link Failure while attempting to access a cell of the target node of a mobility procedure (e.g., during an handover execution procedure),
provided that the wireless device 22 has experienced one or more LBT failures in UL while attempting to transmit a Random Access attempt or executing a Random Access procedure
(optional) if the wireless device 22 has received from a network node 16 a configuration for logging information for an enriched RLF report and/or an enriched Random Access (RA) report and/or other relevant reports, the information concerning the impact of NR Unlicensed operation in transmission of Random Access attempt or execution of a Random Access procedure
the wireless device 22 logs at least part of the second information listed below, related to NR Unlicensed
(optional) if the wireless device 22 has received from a network node 16 a request for reporting at least part of the second information listed below for an enriched RLF report and/or an enriched Random Access (RA) report (for Random Access attempt and execution of Random Access procedure)
the wireless device 22 determines an enriched Radio Link Failure Report and/or an enriched Random Access Report comprising at least part of the second information listed below (for Random Access attempts and Random Access procedure)
the wireless device 22 sends to the network node 16 the enriched Radio Link Failure Report and/or Random Access Report comprising at least part of the second information listed below (for Random Access attempts and Random Access procedure).

Second information concerning the impact of NR Unlicensed operation (e.g., LBT issue) in the transmission of Random Access attempts and execution of Random Access procedure is one or more of:
the Energy Detection Threshold used by the wireless device 22 at the time the LBT failure occurred (or the closest instant in time compared to the LBT failure)
the Energy Detection Threshold(s) used by the wireless device 22 for all channel access attempts (or for each channel access attempts) during a Random Access attempt (for a 4-step Random Access procedure or a 2-step Random Access procedure)
the average/lowest/highest Energy Detection Threshold(s) used by the wireless device 22 for the channel access attempts during a Random Access procedure
the Energy Detection Threshold configured for the wireless device 22 by the network (e.g., network node 16), e.g., the maximum Energy Detection Threshold
the last RSSI measurement before the LBT failure occurred
an indication of LBT failure
indication that a Random Access attempt (for a 4-step Random Access procedure) was successfully transmitted AND Msg2 was not received
   in an embodiment, the wireless device 22 logs that the supervision timer at the wireless device 22 for the random access response message is expired
indication that a Msg A (for a 2-step Random Access procedure) was successfully transmitted AND Msg B was not received
   in an embodiment, the wireless device 22 logs that the supervision timer at the wireless device 22 for the Msg B is expired
indication that Msg 4 was successfully received for a 4-step Random Access procedure
   In an embodiment, the wireless device 22 logs the time elapsed from starting the supervision timer for contention resolution until reception of the Msg 4
indication that Msg B was successfully received for a 2-step Random Access procedure
   In an embodiment, the wireless device 22 logs the time elapsed from starting the supervision timer until reception of the Msg B
the number of LBT failures or channel access attempts during a Random Access attempt (for a 4-step Random Access procedure or a 2-step Random Access procedure)
RSSI measurement(s) per channel access associated to the attempt to transmit a Random Access Preamble (Random Access attempt) in a 4-step Random Access procedure that failed due to LBT failure
RSSI measurement(s) per channel access associated to the attempt to transmit a Msg A in a 2-step (Random Access attempt) Random Access procedure that failed due to LBT failure
RSSI measurement(s) for a successful attempt in transmitting a Random Access Preamble (Random Access attempt) in a 4-step Random Access procedure
RSSI measurement(s) for a successful attempt in transmitting a Msg A (Random Access attempt) in a 2-step Random Access procedure
RSSI measurement(s) for a failed attempt to transmit a Random Access Preamble (Random Access attempt) in a 4-step Random Access procedure
The average/minimum/maximum RSSI value of all RRSI measurements during the attempts to transmit a Random Access Preamble in a 4-step Random Access procedure
The average/minimum/maximum RSSI value of all RRSI measurements during the attempts to transmit a Msg A (Random Access attempt) in a 2-step Random Access procedure
The average/minimum/maximum RSSI value of all RRSI measurements during the attempts to transmit a Msg 3 in the 4-step Random Access procedure
The average/minimum/maximum RSSI value of all RRSI measurements during the attempts to transmit a Random Access Preamble (Random Access attempt) in a 4-step Random Access procedure in conjunction with LBT failures
The average/minimum/maximum RSSI value of all RRSI measurements during the attempts to transmit a Msg A (Random Access attempt) in a 2-step Random Access procedure in conjunction with LBT failures
The average/minimum/maximum RSSI value of all RRSI measurements during the attempts to transmit a Msg 3 in the 4-step Random Access procedure in conjunction with LBT failures
an indication that a Random Access attempt failed due to reaching the maximum number of LBT failures (bt-FailureInstanceMaxCount)
an indication that a matching Random Access Response of a 4-step Random Access procedure has not been received
an indication that a matching Msg B of a 2-step Random Access procedure has not been received
an indication that a matching Preamble Response has not been received

The information described above may be added to various reports generated by the wireless device 22, e.g., to various 3GPP defined reports. For example, the RLF Report, the CEF Report, the Successful Handover Report, the Connection Establishment Failure Report, the PSCell change/addition report. The information is therefore applicable to all the reports where the information described may be included.

### Example Embodiments for Network Nodes 16

In one embodiment, a first network node 16 (e.g., the source node of a handover procedure) may perform one or more of the following:
configure a wireless device 22 for logging an RLF report comprising at least part of first information for an enriched RLF Report and/or an enriched Random Access Report, the first information described in the wireless device 22 embodiments
configure a wireless device 22 for logging an RLF report comprising at least part of second information for an enriched RLF Report and/or an enriched Random Access Report, the second information described in the wireless device 22 embodiments
receive the enriched RLF reports and/or enriched RA reports from a second network node 16
(optionally) determine how to use the enriched RLF reports and/or enriched RA reports for Mobility Robustness Optimization (e.g., excluding them or use a certain weight for them compared to the non-enriched RLF reports and/or the non-enriched RA reports)

In one embodiment, a second network node 16 (e.g., the target network node 16 of a handover procedure) may perform one or more of the following:
request a wireless device 22 to report an enriched RLF report and/or an enriched Random Access report comprising at least part of first information, the first information described in the wireless device 22 embodiments
request a wireless device 22 to report an enriched RLF report and/or an enriched Random Access report comprising at least part of second information, the second information described in the wireless device 22 embodiments
receive from a wireless device 22 an enriched RLF report and/or an enriched Random Access report comprising at least part of first information, the first information described in the wireless device 22 embodiments
receive from a wireless device 22 an enriched RLF report and/or an enriched Random Access report comprising at least part of second information, the second information described in the wireless device 22 embodiments
send to the first network node 16 (e.g., the source network node 16) one or more enriched RLF report and/or an enriched Random Access report including at least part of first information, the first information described in the wireless device 22 embodiments
sends to the first network node 16 one or more enriched RLF report and/or an enriched Random Access report comprising at least part of second information, the second information described in the wireless device 22 embodiments.

In one embodiment, a second network node 16 (e.g., the target network node 16 of a mobility procedure, such as a handover procedure) perform one or more of the following:
optionally determine LBT failures and/or consistent LBT failures causing a delay or preventing the transmission of one or more of: a Random Access Response in a 4-step Random Access procedure, a Msg B in a 2-step Random Access procedure, one or more SSB beams
receives an enriched report, including at least part of first information (as described in the wireless device 22 embodiments) and/or enriched RA report from wireless devices 22 attempting to access the second network node 16 during the execution phase of a mobility procedure and/or and enriched successful handover report and/or a successful PSCell change/addition report and/or a connection establishment failure report
determine that the report concerns a handover failure or mobility procedure failure or a successful execution of a handover or a mobility procedure
determine that the report pertains to a handover procedure which failed in the execution phase due to LBT failure (or due to consistent LBT failure) or pertains to a successful mobility procedure performed under LBT issue or pertains to a connection establishment procedure
(alternative 1) add to the enriched report, an indication indicating that an LBT issue occurred during the mobility procedure e.g., LBT issue occurred during Handover Execution
(alternative 2) add within the enriched report, an indication indicating that an LBT issue occurred during the mobility procedure e.g., LBT issue occurred during the Handover Execution
determine to send the received enriched report to the first network node 16 (e.g., the source network node of the mobility event)
send the enriched report to the first network node 16 (e.g., the source network node of the mobility event)
(optionally) determine how to use the enriched reports for Mobility Robustness Optimization (e.g., excluding them or use a certain weight for them compared to the non-enriched RLF reports and/or the non-enriched RA reports) or mobility load balancing optimization.

A network node 16 receiving the enriched RLF report(s) and/or the enriched RA report(s) and/or any other relevant enriched report containing the enhancements discussed above can use it to determine one or more of the following:
The procedure the wireless device 22 was involved and that triggered the recording of the report that was not necessarily affected by poor network configuration or poor network performance, but it was affected by lack of access to NR-U resources
reconfigure the resources configured for the Random Access partition where LBT failures are detected and that are heavily interfered. As an example, if a RACH partition uses allocated resources over an NR-U channel with high interference, the network node 16 may reconfigure this RACH partition and move its resources over a different NR-U channel or move it to a licensed piece of spectrum.
steer wireless device(s) to radio resources other than the resources configured for the Random Access partition where LBT failures are detected are heavily interfered. In an example, the network node 16 may use its broadcast information to advertise less interfered RACH partitions and to associate them to specific services, so to steer RACH access from the wireless device 22 to such less interfered partitions
trigger a message towards neighbor network nodes/systems requesting to reduce the interference potentially indicating that resources configured for the Random Access partition where LBT failures are detected are heavily interfered,
the resources configured for the Random Access partition where LBT failures are detected are heavily interfered, hence steer wireless device 22 mobility to other cells
use the enriched RLF reports and/or enriched RA reports and/or other relevant reports for Mobility Robustness Optimization (e.g., excluding the received enriched RLF/RA reports in decisions concerning updates of mobility trigger points)
determine that the failures experienced by the wireless device 22 are due to a very high LBT threshold, which in turns implies that an LBT event is triggered at the wireless device 22 even if very low interference is recorded over the NR-U channel
determine from RSSI measurements what is the overall level of interference experienced by the wireless device 22 when LBT occurs. This may result in a number of actions. For example, if such level of interference is relatively low, then trigger internal actions to avoid interfering the channel in question, e.g., reduce interference from other cells (managed by the same RAN node) on the same NR-U channel. Alternatively, signal to other network nodes 16 that might be interfering on this NR-U channels that a reduction of interference on the channel is required.

### Examples of Implementation

In the following, some non-limiting examples of implementation are presented. Impacts on existing 3GPP Technical Specification (i.e., changes to existing 3GPP TS based on the teachings herein) is illustrated in italic, bold and underline).

### First Example (RRC 3GPP TS 38.331)

| | |
|---|---|
| PerRAAttemptInfoList-r16 ::= | SEQUENCE (SIZE (1..200)) OF PerRAAttemptInfo- |

r16

| | |
|---|---|
| PerRAAttemptInfo-r16 ::= | SEQUENCE { |
| contentionDetected-r16 | BOOLEAN OPTIONAL, |
| dlRSRPAboveThreshold-r16 | BOOLEAN OPTIONAL, |

```
  ...,
  [[
```

| | |
|---|---|
| fallbackToFourStepRA-r17 | ENUMERATED {true} OPTIONAL |

```
  ]]
  [[
  matchingRAR-NotReceived-r18 ENUMERATED {true} OPTIONAL
  matchingMsgB-NotReceived-r18 ENUMERATED {true} OPTIONAL
  ]]
}
```

### Second Example (RRC 3GPP TS 38.331)

| | |
|---|---|
| PerRAAttemptInfoList-r16 ::= | SEQUENCE (SIZE (1..200)) OF PerRAAttemptInfo- |

r16

| | |
|---|---|
| PerRAAttemptInfo-r16 ::= | SEQUENCE { |
| contentionDetected-r16 | BOOLEAN OPTIONAL, |
| dlRSRPAboveThreshold-r16 | BOOLEAN OPTIONAL, |

```
  ...,
  [[
```

| | |
|---|---|
| fallbackToFourStepRA-r17 | ENUMERATED {true} OPTIONAL |

```
  ]]
  [[
  matchingRAR-NotReceived-r18 ENUMERATED {true} OPTIONAL
  ]]
}
```

### Third Example (XnAP 3GPP TS 38.423)

### 9.2.3.2 Cause

The purpose of the Cause IE is to indicate the reason for a particular event for the XnAP protocol.

| | | | |
|---|---|---|---|
| IE/Group | | | |
| Name | Presence | Range | IE Type and Reference |

| | | |
|---|---|---|
| CHOICE | M | |
| Cause Group | | |
| >Radio | | |
| Network | | |
| Layer | | |
| >>Radio | M | ENUMERATED |
| Network | | (Cell not Available, |
| Layer | | Handover Desirable for Radio Reasons, |
| Cause | | Handover Target not Allowed, |
| | | Invalid AMF Set ID, |
| | | No Radio Resources Available in Target |
| | | Cell, |
| | | Partial Handover, |
| | | Reduce Load in Serving Cell, |
| | | Resource Optimisation Handover, |
| | | Time Critical Handover, |
| | | TXn_{RELOCoverall} Expiry, |
| | | TXn_{RELOCprep} Expiry, |
| | | Unknown GUAMI ID, |
| | | Unknown Local NG-RAN node UE XnAP |
| | | ID, |
| | | Inconsistent Remote NG-RAN node UE |
| | | XnAP ID, |
| | | Encryption And/Or Integrity Protection |
| | | Algorithms Not Supported, |
| | | Multiple PDU Session ID Instances, |
| | | Unknown PDU Session ID, |
| | | Unknown QoS Flow ID, |
| | | Multiple QoS Flow ID Instances, |
| | | Switch Off Ongoing, |
| | | Not supported 5QI value, |
| | | TXn_{DCoverall} Expiry, |
| | | TXn_{DCprep} Expiry, |
| | | Action Desirable for Radio Reasons, |
| | | Reduce Load, |
| | | Resource Optimisation, |
| | | Time Critical action, |
| | | Target not Allowed, |
| | | No Radio Resources Available, |
| | | Invalid QoS combination, |
| | | Encryption Algorithms Not Supported, |
| | | Procedure cancelled, |
| | | RRM purpose, |
| | | Improve User Bit Rate, |
| | | User Inactivity, |
| | | Radio Connection With UE Lost, |
| | | Failure in the Radio Interface Procedure, |
| | | Bearer Option not Supported, |
| | | UP integrity protection not possible, UP |
| | | confidentiality protection not possible, |
| | | Resources not available for the slice(s), |
| | | UE Maximum integrity protected data rate |
| | | reason, |
| | | CP Integrity Protection Failure, |
| | | UP Integrity Protection Failure, |
| | | Slice(s) not supported by NG-RAN, |
| | | MN Mobility, |
| | | SN Mobility, |
| | | Count reaches max value, |
| | | Unknown Old NG-RAN node UE XnAP |
| | | ID, |
| | | PDCP Overload, |
| | | DRB ID not available, |
| | | Unspecified, |
| | | . . . , |
| | | UE Context ID not known, Non-relocation |
| | | of context, CHO-CPC resources to be |
| | | changed, |
| | | RSN not available for the UP, |
| | | NPN access denied, |
| | | Report Characteristics Empty, |
| | | Existing Measurement ID, |
| | | Measurement Temporarily not Available, |
| | | Measurement not Supported For The |
| | | Object, |
| | | UE Power Saving, |
| | | Not existing NG-RAN node₂ Measurement |
| | | ID, Insufficient UE Capabilities, Normal |
| | | Release, |
| | | Value out of allowed range, SCG activation |
| | | deactivation failure, SCG deactivation |
| | | failure due to data transmission) |
| | | Handover execution failure due to |
| | | consistent LBT failure, |
| | | Handover execution failure due to |
| | | consistent LBT failure in DL, |
| | | Handover execution failure due to |
| | | consistent LBT failure in UL, |
| | | Handover execution failure due to |
| | | consistent LBT failure in UL and DL, |
| | | Handover execution failure due to LBT |
| | | failures in UL, |
| | | Handover execution failure due to LBT |
| | | failures in DL, |
| | | Handover execution failure due to LBT |
| | | failures in UL and DL, |

Therefore, one or more embodiments described herein enable an accurate analysis of the impact of resource unavailability in NR unlicensed in handover preparation, handover execution scenarios and connection establishment procedures.

One or more embodiments described herein have the advantage of providing detailed information from network nodes that executes SON tasks related to mobility optimization or connection establishment, by considering the impact of share spectrum utilization in mobility related procedures.

### Some Examples

Example A1. A network node 16 configured to communicate with a wireless device 22, the network node 16 configured to, and/or comprising a radio interface 62 and/or comprising processing circuitry 68 configured to:
receive a transmission of an enriched report including enrichment information, the enrichment information being related to an impact of unlicensed wireless spectrum operation in mobility procedures; and
determine how to use the enrichment report for mobility robustness optimization.

Example A2. The network node 16 of Example A1, wherein the processing circuitry 68 is configured to cause transmission of a configuration to the wireless device 22 for logging the enrichment information for one of a radio link failure, RLF, report and a random access, RA, report.

Example A3. The network node 16 of Example A1, wherein the report is related to one of:
a radio resource control, RRC, measurement report;
   random access attempts; and
   random access procedures.

Example A4. The network node 16 of Example A3, wherein, when the report is related to the RRC measurement report, the enrichment information corresponds to any of:
an energy detection threshold used by the wireless device 22 at a time the LBT failure occurred;
an energy detection threshold configured for the wireless device 22 by the network node 16;
an actual energy detection threshold used by the wireless device 22 as part of a LBT procedure;
a most recent available RSSI measurement before the LBT failure occurred;
a flag indicating that the RRC measurement report could not be sent due to LBT failure;
a flag indicating that the RRC measurement report could not be sent due to consistent LBT failure;
the number of times the wireless devices 22 has tried to access the channel before successful transmission of the measurement report;
RSSI measurement per channel access taken for each attempt to transmit the RRC Measurement Report message that failed due to LBT failure;
an indication of what message was attempted to be signaled for each attempted channel access attempt;
an average RSSI value of all RSSI measurements during the at least one attempt to transmit the RRC measurement report message; and
a number of LBT failures that occurred while the wireless device 22 was attempting to transmit the RRC measurement report and a notification that the attempt was blocked due to LBT failures.

Example A5. The network node 16 of Example A3, wherein, when the report is related to the random access procedure that is toward a target network node 16 of a mobility event, the enrichment information corresponds to any of:
an energy detection threshold used by the wireless device 22 at a time the LBT failure occurred;
an energy detection threshold used by the wireless device 22 for all channel access attempts during a random access attempt;
one of an average, lowest and highest energy detection threshold used by the wireless device 22 for the channel access attempts during a random access procedure;
an energy detection threshold configured for the wireless device 22 by the network node 16;
a last RSSI measurement before the LBT failure occurred;
an indication of LBT failure;
an indication that a random access attempt was successfully transmitted and a message 2, Msg2, was not received;
an indication that a message A, Msg A, for a 2-step random access procedure was successfully transmitted and a message B, Msg B, was not received;
an indication that a message 4, Msg 4, was successfully received for a 4-step random access procedure;
an indication that a message B, Msg B, was successfully received for a 2-step random access procedure;
a number of LBT failures or channel access attempts during a random access attempt;
a RSSI measurement per channel access associated to an attempt to transmit a random access preamble in a 4-step random access procedure that failed due to LBT failure;
a RSSI measurement per channel access associated to an attempt to transmit a message A, Msg A, in a 2-step random access procedure that failed due to LBT failure;
a RSSI measurement for a successful attempt in transmitting a random access preamble in a 4-step random access procedure;
a RSSI measurement for a successful attempt in transmitting a message A, Msg A, in a 2-step random access procedure;
a RSSI measurement for a failed attempt to transmit a random access preamble in a 4-step random access procedure;
one of an average, minimum, and maximum RSSI value of all RRSI measurements during at least one attempt to transmit a random access preamble in a 4-step random access procedure;
one of an average, minimum, and maximum RSSI value of all RRSI measurements during at least one attempt to transmit a message A, Msg A, in a 2-step random access procedure;
one of an average, minimum, and maximum RSSI value of all RRSI measurements during at least one attempt to transmit a message 3, Msg 3, in the 4-step random access procedure;
one of an average, minimum, and maximum RSSI value of all RRSI measurements during at least one attempt to transmit a random access preamble in a 4-step random access procedure in conjunction with LBT failures;
one of an average, minimum, and maximum RSSI value of all RRSI measurements during at least one attempt to transmit a message A, Msg A, in a 2-step random access procedure in conjunction with LBT failures;
one of an average, minimum, and maximum RSSI value of all RRSI measurements during at least one attempt to transmit a message 3, Msg 3, in the 4-step random access procedure in conjunction with LBT failures;
an indication that a random access attempt failed due to reaching a maximum number of LBT failures;
an indication that a matching random access response of a 4-step random access procedure has not been received;
an indication that a matching message B, Msg B, of a 2-step random access procedure has not been received; and
an indication that a matching preamble response has not been received.

Example B1. A method implemented in a network node 16 that is configured to communicate with a wireless device 22, the method comprising:
receiving a transmission of an enriched report including enrichment information, the enrichment information being related to an impact of unlicensed wireless spectrum operation in mobility procedures; and
determining how to use the enrichment report for mobility robustness optimization

Example B2. The method of Example B1, further comprising causing transmission of a configuration to the wireless device 22 for logging the enrichment information for one of a radio link failure, RLF, report and a random access, RA, report.

Example B3. The method of Example B1, wherein the report is related to one of:
a radio resource control, RRC, measurement report;
   random access attempts; and
   random access procedures.

Example B4. The method of Example B3, wherein, when the report is related to the RRC measurement report, the enrichment information corresponds to any of:
an energy detection threshold used by the wireless device 22 at a time the LBT failure occurred;
an energy detection threshold configured for the wireless device 22 by the network node;
an actual energy detection threshold used by the wireless device 22 as part of a LBT procedure;
a most recent available RSSI measurement before the LBT failure occurred;
a flag indicating that the RRC measurement report could not be sent due to LBT failure;
a flag indicating that the RRC measurement report could not be sent due to consistent LBT failure;
the number of times the wireless devices 22 has tried to access the channel before successful transmission of the measurement report;
RSSI measurement per channel access taken for each attempt to transmit the RRC Measurement Report message that failed due to LBT failure;
an indication of what message was attempted to be signaled for each attempted channel access attempt;
an average RSSI value of all RSSI measurements during the at least one attempt to transmit the RRC measurement report message; and
a number of LBT failures that occurred while the wireless device 22 was attempting to transmit the RRC measurement report and a notification that the attempt was blocked due to LBT failures.

Example B5. The method of Example B3, wherein, when the report is related to the random access procedure that is toward a target network node 16 of a mobility event, the enrichment information corresponds to any of:
an energy detection threshold used by the wireless device 22 at a time the LBT failure occurred;
an energy detection threshold used by the wireless device 22 for all channel access attempts during a random access attempt;
one of an average, lowest and highest energy detection threshold used by the wireless device 22 for the channel access attempts during a random access procedure;
an energy detection threshold configured for the wireless device 22 by the network node 16;
a last RSSI measurement before the LBT failure occurred;
an indication of LBT failure;
an indication that a random access attempt was successfully transmitted and a message 2, Msg2, was not received;
an indication that a message A, Msg A, for a 2-step random access procedure was successfully transmitted and a message B, Msg B, was not received;
an indication that a message 4, Msg 4, was successfully received for a 4-step random access procedure;
an indication that a message B, Msg B, was successfully received for a 2-step random access procedure;
a number of LBT failures or channel access attempts during a random access attempt;
a RSSI measurement per channel access associated to an attempt to transmit a random access preamble in a 4-step random access procedure that failed due to LBT failure;
a RSSI measurement per channel access associated to an attempt to transmit a message A, Msg A, in a 2-step random access procedure that failed due to LBT failure;
a RSSI measurement for a successful attempt in transmitting a random access preamble in a 4-step random access procedure;
a RSSI measurement for a successful attempt in transmitting a message A, Msg A, in a 2-step random access procedure;
a RSSI measurement for a failed attempt to transmit a random access preamble in a 4-step random access procedure;
one of an average, minimum, and maximum RSSI value of all RRSI measurements during at least one attempt to transmit a random access preamble in a 4-step random access procedure;
one of an average, minimum, and maximum RSSI value of all RRSI measurements during at least one attempt to transmit a message A, Msg A, in a 2-step random access procedure;
one of an average, minimum, and maximum RSSI value of all RRSI measurements during at least one attempt to transmit a message 3, Msg 3, in the 4-step random access procedure;
one of an average, minimum, and maximum RSSI value of all RRSI measurements during at least one attempt to transmit a random access preamble in a 4-step random access procedure in conjunction with LBT failures;
one of an average, minimum, and maximum RSSI value of all RRSI measurements during at least one attempt to transmit a message A, Msg A, in a 2-step random access procedure in conjunction with LBT failures;
one of an average, minimum, and maximum RSSI value of all RRSI measurements during at least one attempt to transmit a message 3, Msg 3, in the 4-step random access procedure in conjunction with LBT failures;
an indication that a random access attempt failed due to reaching a maximum number of LBT failures;
an indication that a matching random access response of a 4-step random access procedure has not been received;
an indication that a matching message B, Msg B, of a 2-step random access procedure has not been received; and
an indication that a matching preamble response has not been received.

Example C1. A wireless device 22 configured to communicate with a network node 16, the wireless device 22 configured to, and/or comprising a radio interface 82 and/or processing circuitry 84 configured to:
log enrichment information used to enrich a report, the enrichment information being related to an impact of unlicensed wireless spectrum operation in mobility procedures; and
cause transmission of an enriched report including the enrichment information.

Example C2. The wireless device 22 of Example C1, wherein the processing circuitry 84 is configured to receive a configuration for logging the enrichment information for one of a radio link failure, RLF, report and a random access, RA, report.

Example C3. The wireless device 22 of Example C1, wherein the report is related to one of:
a radio resource control, RRC, measurement report;
   random access attempts; and
   random access procedures.

Example C4. The wireless device 22 of Example C3, wherein, when the report is related to the RRC measurement report, the processing circuitry 84 being further configured to:
determine a listen before talk, LBT, procedure has failed at least once when trying to send the RRC measurement report, the logging of the enrichment information being based on the determination of the at least one failure of the LBT procedure.

Example C5. The wireless device 22 of any one of Examples C1-C4, wherein the enrichment information corresponds to any of:
an energy detection threshold used by the wireless device 22 at a time the LBT failure occurred;
an energy detection threshold configured for the wireless device 22 by the network node 16;
an actual energy detection threshold used by the wireless device 22 as part of a LBT procedure;
a most recent available RSSI measurement before the LBT failure occurred;
a flag indicating that the RRC measurement report could not be sent due to LBT failure;
a flag indicating that the RRC measurement report could not be sent due to consistent LBT failure;
the number of times the wireless devices 22 has tried to access the channel before successful transmission of the measurement report;
RSSI measurement per channel access taken for each attempt to transmit the RRC Measurement Report message that failed due to LBT failure;
an indication of what message was attempted to be signaled for each attempted channel access attempt;
an average RSSI value of all RSSI measurements during the at least one attempt to transmit the RRC measurement report message; and
a number of LBT failures that occurred while the wireless device 22 was attempting to transmit the RRC measurement report and a notification that the attempt was blocked due to LBT failures.

Example C6. The wireless device 22 of Example C3, wherein, when the report is related to the random access procedure that is toward a target network node of a mobility event, the processing circuitry being further configured to:
detect a radio link failure, RLF, while attempting to access a cell of a target network node of a mobility procedure; and
determine a listen before talk, LBT, failure in the uplink occurred while attempting to transmit a random access message or executing a random access procedure.

Example C7. The wireless device 22 of any one of Examples C1-C4 and C6, wherein the enrichment information corresponds to any of:
an energy detection threshold used by the wireless device 22 at a time the LBT failure occurred;
an energy detection threshold used by the wireless device 22 for all channel access attempts during a random access attempt;
one of an average, lowest and highest energy detection threshold used by the wireless device 22 for the channel access attempts during a random access procedure;
an energy detection threshold configured for the wireless device 22 by the network node 16;
a last RSSI measurement before the LBT failure occurred;
an indication of LBT failure;
an indication that a random access attempt was successfully transmitted and a message 2, Msg2, was not received;
an indication that a message A, Msg A, for a 2-step random access procedure was successfully transmitted and a message B, Msg B, was not received;
an indication that a message 4, Msg 4, was successfully received for a 4-step Random Access procedure;
an indication that a message B, Msg B, was successfully received for a 2-step Random Access procedure;
an number of LBT failures or channel access attempts during a random access attempt;
a RSSI measurement per channel access associated to an attempt to transmit a random access preamble in a 4-step random access procedure that failed due to LBT failure;
a RSSI measurement per channel access associated to an attempt to transmit a message A, Msg A, in a 2-step random access procedure that failed due to LBT failure;
a RSSI measurement for a successful attempt in transmitting a random access preamble in a 4-step random access procedure;
a RSSI measurement for a successful attempt in transmitting a message A, Msg A, in a 2-step random access procedure;
a RSSI measurement for a failed attempt to transmit a random access preamble in a 4-step random access procedure;
one of an average, minimum, and maximum RSSI value of all RRSI measurements during at least one attempt to transmit a random access preamble in a 4-step random access procedure;
one of an average, minimum, and maximum RSSI value of all RRSI measurements during at least one attempt to transmit a message A, Msg A, in a 2-step Random Access procedure;
one of an average, minimum, and maximum RSSI value of all RRSI measurements during at least one attempt to transmit a message 3, Msg 3, in the 4-step Random Access procedure;
one of an average, minimum, and maximum RSSI value of all RRSI measurements during at least one attempt to transmit a random access preamble in a 4-step Random Access procedure in conjunction with LBT failures;
one of an average, minimum, and maximum RSSI value of all RRSI measurements during at least one attempt to transmit a message A, Msg A, in a 2-step random access procedure in conjunction with LBT failures;
one of an average, minimum, and maximum RSSI value of all RRSI measurements during at least one attempt to transmit a message 3, Msg 3, in the 4-step Random Access procedure in conjunction with LBT failures;
an indication that a random access attempt failed due to reaching a maximum number of LBT failures;
an indication that a matching random access response of a 4-step random access procedure has not been received;
an indication that a matching message B, Msg B, of a 2-step random access procedure has not been received; and
an indication that a matching preamble response has not been received.

Example D1. A method implemented in a wireless device 22 that is configured to communicate with a network node 16, the method comprising:
logging enrichment information used to enrich a report, the enrichment information being related to an impact of unlicensed wireless spectrum operation in mobility procedures; and
causing transmission of an enriched report including the enrichment information

Example D2. The method of Example D1, further comprising receiving a configuration for logging the enrichment information for one of a radio link failure, RLF, report and a random access, RA, report.

Example D3. The method of Example D1, wherein the report is related to one of:
a radio resource control, RRC, measurement report;
   random access attempts; and
   random access procedures.

Example D4. The method of Example D3, wherein, when the report is related to the RRC measurement report;
the method further comprising determining a listen before talk, LBT, procedure has failed at least once when trying to send the RRC measurement report, the logging of the enrichment information being based on the determination of the at least one failure of the LBT procedure.

Example D5. The method of any one of Examples D1-D4, wherein the enrichment information corresponds to any of:
an energy detection threshold used by the wireless device 22 at a time the LBT failure occurred;
an energy detection threshold configured for the wireless device 22 by the network node 16;
an actual energy detection threshold used by the wireless device 22 as part of a LBT procedure;
a most recent available RSSI measurement before the LBT failure occurred;
a flag indicating that the RRC measurement report could not be sent due to LBT failure;
a flag indicating that the RRC measurement report could not be sent due to consistent LBT failure;
the number of times the wireless devices 22 has tried to access the channel before successful transmission of the measurement report;
RSSI measurement per channel access taken for each attempt to transmit the RRC Measurement Report message that failed due to LBT failure;
an indication of what message was attempted to be signaled for each attempted channel access attempt;
an average RSSI value of all RSSI measurements during the at least one attempt to transmit the RRC measurement report message; and
a number of LBT failures that occurred while the wireless device 22 was attempting to transmit the RRC measurement report and a notification that the attempt was blocked due to LBT failures.

Example D6. The method of Example D3, wherein, when the report is related to the random access procedure that is toward a target network node 16 of a mobility event; and
the method further comprising:
   detecting a radio link failure, RLF, while attempting to access a cell of a target network node of a mobility procedure; and
   determining a listen before talk, LBT, failure in the uplink occurred while attempting to transmit a random access message or executing a random access procedure.

Example D7. The method of any one of Examples D1-D4 and D6, wherein the enrichment information corresponds to any of:
an energy detection threshold used by the wireless device 22 at a time the LBT failure occurred;
an energy detection threshold used by the wireless device 22 for all channel access attempts during a random access attempt;
one of an average, lowest and highest energy detection threshold used by the wireless device 22 for the channel access attempts during a random access procedure;
an energy detection threshold configured for the wireless device 22 by the network node 16;
a last RSSI measurement before the LBT failure occurred;
an indication of LBT failure;
an indication that a random access attempt was successfully transmitted and a message 2, Msg2, was not received;
an indication that a message A, Msg A, for a 2-step random access procedure was successfully transmitted and a message B, Msg B, was not received;
an indication that a message 4, Msg 4, was successfully received for a 4-step Random Access procedure;
an indication that a message B, Msg B, was successfully received for a 2-step random access procedure;
an number of LBT failures or channel access attempts during a random access attempt;
a RSSI measurement per channel access associated to an attempt to transmit a random access Preamble in a 4-step random access procedure that failed due to LBT failure;
a RSSI measurement per channel access associated to an attempt to transmit a message A, Msg A, in a 2-step random access procedure that failed due to LBT failure;
a RSSI measurement for a successful attempt in transmitting a Random Access Preamble in a 4-step Random Access procedure;
a RSSI measurement for a successful attempt in transmitting a message A, Msg A, in a 2-step Random Access procedure;
a RSSI measurement for a failed attempt to transmit a random access preamble in a 4-step random access procedure;
one of an average, minimum, and maximum RSSI value of all RRSI measurements during at least one attempt to transmit a random access preamble in a 4-step Random Access procedure;
one of an average, minimum, and maximum RSSI value of all RRSI measurements during at least one attempt to transmit a message A, Msg A, in a 2-step random access procedure;
one of an average, minimum, and maximum RSSI value of all RRSI measurements during at least one attempt to transmit a message 3, Msg 3, in the 4-step random access procedure;
one of an average, minimum, and maximum RSSI value of all RRSI measurements during at least one attempt to transmit a random access preamble in a 4-step random access procedure in conjunction with LBT failures;
one of an average, minimum, and maximum RSSI value of all RRSI measurements during at least one attempt to transmit a message A, Msg A, in a 2-step random access procedure in conjunction with LBT failures;
one of an average, minimum, and maximum RSSI value of all RRSI measurements during at least one attempt to transmit a message 3, Msg 3, in the 4-step random access procedure in conjunction with LBT failures;
an indication that a random access attempt failed due to reaching a maximum number of LBT failures;
an indication that a matching random access response of a 4-step random access procedure has not been received;
an indication that a matching message B, Msg B, of a 2-step random access procedure has not been received; and
an indication that a matching Preamble Response has not been received.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

### Abbreviation Explanation

3GPP 3^{rd} Generation Partnership Project
5G 5th Generation
5GC 5G Core network
5GS 5th Generation System
AMF Access and Mobility Management Function
ASN.1 Abstract Syntax Notation One
AT Attention
AR Augmented Reality
AS Access Stratum
CGI Cell Global Identity
CN Core Network
CP Control Plane
CU Central Unit
CU-CP Central Unit Control Plane
CU-UP Central Unit User Plane
DU Distributed Unit
DASH Dynamic Adaptive Streaming over HTTP
DC Dual Connectivity
DL Downlink
DNS Domain Name System
DU Distributed Unit
E-CGI E-UTRAN CGI
eNB Evolved Node B/E-UTRAN Node B
en-gNB A gNB acting as a secondary node in an EN-DC scenario (i.e., in a DC scenario with an eNB as the master node and a gNB as the secondary node.
EN E-UTRAN-NR
EPC Evolved Packet Core
EPS Evolved Packet System
E-UTRA Evolved UTRA
E-UTRAN/EUTRAN Evolved UTRAN
gNB Radio base station in NR
HSS Home Subscriber Server
HTTP Hypertext Transfer Protocol
IAB Integrated Access and Backhaul
ID Identifier/Identity
IE Information Element
LTE Long Term Evolution
MAC Medium Access Control
MCC Mobile Country Code
MCE Measurement Collection Entity/Measurement Collector Entity
MDT Minimization of Drive Tests
MME Mobility Management Entity
MNC Mobile Network Code
MTSI Multimedia Telephony Service for IMS
N3IWF Non-3GPP Interworking Function
NG Next Generation
NG The interface between an NG-RAN and a 5GC.
NGAP NG Application Protocol
NG-RAN NG Radio Access Network
NID Network identifier
NR New Radio
NWDAF Network Data Analytics Function
O&M Operation and Maintenance
OAM Operation and Maintenance
PDCP Packet Data Convergence Protocol
PDU Protocol Data Unit
PLMN Public Land Mobile Network
QMC QoE Measurement Collection
QoE Quality of Experience
RAN Radio Access Network
RAT Radio Access Technology
RLC Radio Link Control
RNC Radio Network Controller
RRC Radio Resource Control
RVQoE RAN Visible QoE
S1 The interface between the RAN and the CN in LTE.
S1AP S1 Application Protocol
S-NSSAI Single Network Slice Selection Assistance Information
SMO Service Management and Orchestration
SRB Signaling Radio Bearer
TA Tracking Area
TCE Trace Collection Entity/Trace Collector Entity
TNGF Trusted Non-3GPP Gateway Function
TWIF Trusted WLAN Interworking Function
UDM Unified Data Management
UE User Equipment
UMTS Universal Mobile Telecommunication System
URI Uniform Resource Identifier
URL Uniform Resource Locator Uniform Resource Locator
UTRA Universal Terrestrial Radio Access
UTRAN Universal Terrestrial Radio Access Network
WLAN Wireless Local Area Network
Xn The interface between two gNBs in NR.
XnAP Xn Application Protocol

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-19. (canceled)

20. A method implemented by a network node that is configured to communicate with a wireless device, the method comprising:
receiving an enriched report that has been enriched with enrichment information, the enrichment information being related to an impact of unlicensed wireless spectrum operation on mobility procedures; and
performing at least one action associated with a mobility related procedure, the at least one action being associated with at least on the enrichment information.

21. The method of claim 20, further comprising transmitting a configuration to the wireless device for logging the enrichment information for one of a radio link failure, RLF, or a random access, RA, procedure.

22. The method of claim 20, wherein the enriched report is associated with one of:
a random access attempt towards a target network node of a mobility event; or
performing a random access procedure towards the target network node of the mobility event.

23. The method of claim 22, wherein the enriched report is associated with the random access procedure, the enrichment information includes at least one of:
a last received signal strength indicator, RSSI, measurement before a listen before talk, LBT, failure occurred;
an indication of LBT failure;
an indication that a random access attempt was successfully transmitted and a message 2, Msg2, was not received;
an indication that a random access response of a 4-step random access procedure has not been received;
an indication that a message B, Msg B, of a 2-step random access procedure has not been received; or
an indication that a preamble response has not been received.

24. The method of claim 20, wherein the network node is a target network node of a handover procedure; and
the at least one action includes one of:
transmitting the enriched report to a source network node of the handover procedure for use in a mobility optimization;
performing mobility optimization based on the enrichment information;
excluding the enriched report when performing mobility optimization; or
applying a first logical weight to the enriched report when performing mobility optimization, the first logical weight being different than a second logical weight applied to a non-enriched report.

25. The method of claim 20, further comprising requesting the enriched report;
the network node is a target network node of a handover procedure; and
the at least one action includes determining a failure type of a plurality of failure types associated with the enriched report.

26. The method of claim 20, wherein the network node is a target network node of a handover procedure; and
the method further comprising one of:
determining the enriched report is associated with a handover procedure that failed in an execution phase due to listen before talk, LBT, failure;
determining the enriched report is associated with a successful mobility procedure under a LBT issue; or
determining the enriched report is associated with a connection establishment procedure.

27. The method of claim 20, further comprising assigning respective logical weights to the enrichment information and non-enrichment information included in the enriched report, the at least one action being based on the assigned logical weights.

28. The method of claim 27, wherein the at least one action comprises changing at least one mobility parameter associated with the wireless device, the changing of the at least one mobility parameter not being based on the non-enrichment information due to the assigned logical weight of the non-enrichment information.

29. The method of claim 27, further comprising:
determining at least one mobility parameter associated with the wireless device did not cause a radio link failure, RLF; and
determining the RLF was caused based at least on the unlicensed wireless spectrum operation.

30. The method of claim 20, further comprising assigning respective logical weights to the enrichment information and non-enrichment information included in the enriched report, the at least one action being based on the assigned logical weights; and
the network node is a source network node.

31. A method implemented by a wireless device that is configured to communicate with a network node, the method comprising:
logging enrichment information, the enrichment information being related to an impact of unlicensed wireless spectrum operation in mobility procedures; and
transmitting an enriched report including the enrichment information.

32. The method of claim 31, further comprising receiving a configuration for logging the enrichment information for one of a radio link failure, RLF, or a random access, RA, procedure.

33. The method of claim 31, wherein the enriched report is associated with one of:
a random access attempt toward a target network node of a mobility event; and
performing a random access procedure towards the target network node of the mobility event.

34. The method of claim 33, wherein the enriched report is associated with the random access procedure, the enrichment information includes at least one of:
a last received signal strength indicator, RSSI, measurement before a listen before talk, LBT, failure occurred;
an indication of LBT failure;
an indication that a random access attempt was successfully transmitted and a message 2, Msg2, was not received;
an indication that a random access response of a 4-step random access procedure has not been received;
an indication that a message B, Msg B, of a 2-step random access procedure has not been received; or
an indication that a preamble response has not been received.

35. The method of claim 31, wherein the network node is a target network node of a handover procedure.

36. The method of claim 31, further comprising receiving a request for the enriched report.

37. The method of claim 31, further comprising receiving an indication of a change to at least one mobility parameter, the change not being based on non-enrichment information included in the enrichment report.

38.-40. (canceled)

41. A wireless device configured to communicate with a network node, the wireless device configured to:
log enrichment information, the enrichment information being related to an impact of unlicensed wireless spectrum operation in mobility procedures; and
cause transmission of an enriched report including the enrichment information.

42. The wireless device of claim 41, wherein the wireless device is configured to receive a configuration for logging the enrichment information for one of a radio link failure, RLF, or a random access, RA, procedure.

43. A network node configured to communicate with a wireless device, the network node configured to:
receive an enriched report that has been enriched with enrichment information, the enrichment information being related to an impact of unlicensed wireless spectrum operation on mobility procedures; and
perform at least one action associated with a mobility related procedure, the at least one action being associated with at least on the enrichment information.

44. The network node of claim 43, wherein the network node is configured to transmit a configuration to the wireless device for logging the enrichment information for one of a radio link failure, RLF, or a random access, RA, procedure.
